(19) United States
(12) Patent Application Publication
(10) Pub. No.: US 2019/0218773 A1
(43) Pub. Date: Jul. 18, 2019

(54) LIGHT-SHIELDING DEVICE, LIGHT-SHIELDING METHOD, AND PROGRAM

(71) Applicant: SONY CORPORATION, TOKYO (JP)

(72) Inventors: SHUNICHI SUWA, KANAGAWA (JP); JUNICHI REKIMOTO, KANAGAWA (JP); KUNIHIKO NAGAMINE, KANAGAWA (JP); YOSHINOBU ARISUMI, TOKYO (JP)

(21) Appl. No.: 16/328,754

(22) PCT Filed: Sep. 14, 2017
(86) PCT No.: PCT/JP2017/033203

§ 371 Date: Feb. 27, 2019

(30) Foreign Application Priority Data
Sep. 27, 2016 (JP) 2016-187821

(51) Int. Cl. E04B 2/74; E06B 9/24; G05B 19/04; G06F 3/01

(52) U.S. Cl. CPC E04B 2/74; E06B 9/24; G02F 1/133512; G06F 3/013; G05B 19/041

(57) ABSTRACT

The present technology relates to a light-shielding device, a light-shielding method, and a program which make an object that is meant to be invisible to human beings enter a state in which the object is hidden so as to be invisible to eyes, or make an object that is meant to be visible enter a state in which the object is visible to eyes in correspondence with a state of the periphery of a light-shielding wall.

A light-shielding wall, which partitions two spaces and includes a plurality of panels capable of being controlled to a transmitting state in which light is transmitted or a light-shielding state in which light is shielded, is used as a window, a position of user' s eyes in the vicinity of the light-shielding wall is detected, and in a case where the position of the user's eyes is present in the vicinity of the light-shielding wall, a panel, which corresponds to the position of the user's eyes, of the light-shielding wall is controlled to the transmitting state, and the other panels are controlled to the light-shielding state. The present disclosure is applicable to the light-shielding wall.

### TECHNICAL FIELD

The present technology relates to a light-shielding device, a light-shielding method, and a program, and more particularly, to a light-shielding device, a light-shielding method, and a program which make an object that is meant to be invisible enter a state in which the object is hidden so as to be invisible to eyes or is less likely to be visible to eyes, or make an object that is meant to be visible enter a state in which the object is likely to be visible to eyes in correspondence with a state of the vicinity of a light-shielding wall.

### BACKGROUND ART

A light-shielding device that makes an object that is meant to be visible to human beings be visible while hiding an object that is meant to be invisible to human beings is proposed (refer to Patent Document 1)

### CITATION LIST

### Patent Document

Patent Document 1: International Publication No. 2014/010498

### SUMMARY OF THE INVENTION

### Problems to be Solved by the Invention

However, the light-shielding device described in Patent Document 1 does not have a configuration of making an object that is meant to be invisible to human beings enter a state in which the object is hidden so as to be invisible to eyes or making an object that is meant to be visible enter a state in which the object is visible to eyes in correspondence with a state of the vicinity of a light-shielding wall.

The present disclosure has been made in consideration such situations, and an object thereof is to make an object that is meant to be invisible enter a state in which the object is hidden so as to be invisible to eyes or is less likely to be visible to eyes, or to make an object that is meant to be visible enter a state in which the object is likely to be visible to eyes in correspondence with a state of the vicinity of a light-shielding wall.

### Solutions to Problems

According to an aspect of the present disclosure, there is provided a light-shielding device including: a light-shielding wall that partitions a first space and a second space and includes a plurality of regions capable of being controlled to a transmitting state in which light is transmitted or a light-shielding state in which light is shielded; a light-shielding and transmitting information generation unit that generates light-shielding and transmitting information for controlling the transmitting state or the light-shielding state of a position of each of the plurality of regions on the basis of information indicating a state of the vicinity of a light-shielding wall; and a control unit that controls the transmitting state or the light-shielding state of the plurality of regions of the light-shielding wall on the basis of the light-shielding and transmitting information generated by the light-shielding and transmitting information generation unit.

The light-shielding wall may be a window that separates the first space and the second space, the information indicating the state of the vicinity of the light-shielding wall may be information indicating whether or not user's eyes are present in the vicinity of the window constituted by the light-shielding wall, and the light-shielding and transmitting information generation unit may generate light-shielding and transmitting information for controlling the transmitting state or the light-shielding state of the position of each of the plurality of regions on the basis of information that indicates the state of the vicinity of the light-shielding wall and indicates whether or not the user's eyes are present in the vicinity of the window constituted by the light-shielding wall.

On the basis of the information that indicates the state of the vicinity of the light-shielding wall and indicates whether or not the user's eyes are present in the vicinity of the window constituted by the light-shielding wall, the light-shielding and transmitting information generation unit may generate light-shielding and transmitting information for controlling a region, which corresponds to a position of the user's eyes, in the light-shielding wall to the transmitting state, and controlling the other regions to the light-shielding state in a case where the position of the user's eyes is present in the vicinity of the window constituted by the light-shielding wall, and for controlling the entirety of the regions of the light-shielding wall to the light-shielding state in a case where the position of the user's eyes is not present in the vicinity of the window constituted by the light-shielding wall.

The first space may be a space in which an observation target exists, and the second space may be an observation space for observation of the observation target, the information indicating the state of the vicinity of the light-shielding wall may further include information indicating whether or not the light-shielding wall exists in a visual field of the observation target, and the light-shielding and transmitting information generation unit may generate light-shielding and transmitting information for controlling the transmitting state or the light-shielding state of the position of each of the plurality of regions on the basis of the information indicating whether or not the light-shielding wall exists in the visual field of the observation target, and the information indicating whether or not the user's eyes are present in the vicinity of the window constituted by the light-shielding wall.

The light-shielding and transmitting information generation unit may generate light-shielding and transmitting information for controlling the transmitting state or the light-shielding state of the position of each of the plurality of regions on the basis of the information indicating whether or not the user's eyes are present in the vicinity of the window constituted by the light-shielding wall in a case where the light-shielding wall exists in the visual field of the observation target, and light-shielding and transmitting information for controlling the entirety of the plurality of regions to the transmitting state in a case where the light-shielding wall does not exist in the visual field of the observation target.

The case where the light-shielding wall does not exist in the visual field of the observation target may include a case where the observation target is sufficiently spaced away from the light-shielding wall.

The light-shielding wall may be a floor that separates the first space and the second space, the information indicating the state of the vicinity of the light-shielding wall may be information indicating whether or not a user steps into a new position on the floor, and the light-shielding and transmitting information generation unit may generate light-shielding and transmitting information for controlling the transmitting state or the light-shielding state of the position of each of the plurality of regions on the basis of the information that indicates the state in the vicinity of the light-shielding wall and indicates whether or not the user steps into the new position on the floor.

The light-shielding and transmitting information generation unit may generate light-shielding and transmitting information for controlling the region at a stepped position of a foot of a user to the transmitting state in a case where the user steps into a new position on the floor, and controlling the other regions to the light-shielding state.

The light-shielding and transmitting information generation unit may generate light-shielding and transmitting information for controlling the region at a stepped position of a foot of a user to the light-shielding state in a case where the user steps into a new position on the floor, and controlling the other regions to the transmitting state.

The light-shielding wall may be a window that separates the first space and the second space, the light-shielding device may further includes a lock control unit that control locking and unlocking of a lock of the window, the information indicating the state in the vicinity of the light-shielding wall may be information indicating whether or not a suspicious person is present, the light-shielding and transmitting information generation unit may generate light-shielding and transmitting information for controlling the transmitting state or the light-shielding state of the position of each of the plurality of regions on the basis of the information that indicates the state of the vicinity of the light-shielding wall and indicates whether or not the suspicious person is present, and the lock control unit controls locking or unlocking of the lock of the window on the basis of the information indicating whether or not suspicious person is present.

In a case where the suspicious person is present, the light-shielding and transmitting information generation unit may generate light-shielding and transmitting information for controlling a region in a visual field of the suspicious person to the light-shielding state and controlling the other regions to the transmitting state, and the lock control unit may control the lock of the window to be locked. In a case where the suspicious person is not present, the light-shielding and transmitting information generation unit may generate light-shielding and transmitting information for controlling the entirety of the regions to the transmitting state, and the lock control unit may control the lock of the window to be unlocked.

The light-shielding wall is a road wall that separates a road and a resident area at a roadside, the information indicating the state of the vicinity of the light-shielding wall may be information indicating whether or not a vehicle, in which the resident area is visible to an occupant through the light-shielding wall in the transmitting state, travels on the road, and the light-shielding and transmitting information generation unit may generate the light-shielding and transmitting information for controlling the transmitting state or the light-shielding state of the position of each of the plurality of regions on the basis of the information that indicates the state in the vicinity of the light-shielding wall and indicates whether or not the vehicle, in which the resident area is visible to the occupant through the light-shielding wall in the transmitting state, travels on the road.

On the basis of the information that indicates the state of the vicinity of the light-shielding wall and indicates whether or not the vehicle, in which the resident area is visible to the occupant through the light-shielding wall in the transmitting state, travels on the road, the light-shielding and transmitting information generation unit may generate light-shielding and transmitting information for controlling a region in the light-shielding wall in which the resident area is visible to the occupant to the light-shielding state and controlling the other regions to the transmitting state in a case where the vehicle, in which the resident area is visible to the occupant through the light-shielding wall in the transmitting state, travels on the road, and for controlling the entirety of the regions of the light-shielding wall to the transmitting state in a case where the vehicle, in which the resident area is visible to the occupant through the light-shielding wall in the transmitting state, does not travel on the road.

According to another aspect of the present disclosure, there is provided a light-shielding method of a light-shielding device including a light-shielding wall that partitions a first space and a second space and includes a plurality of regions capable of being controlled to a transmitting state in which light is transmitted or a light-shielding state in which light is shielded. The method includes: generating light-shielding and transmitting information for controlling the transmitting state or the light-shielding state of a position of each of the plurality of regions on the basis of information indicating a state of the vicinity of the light-shielding wall; and controlling the transmitting state or the light-shielding state of the plurality of regions of the light-shielding wall on the basis of the light-shielding and transmitting information.

According to still another aspect of the present disclosure, there is provided a program that allows a computer to function as: a light-shielding wall that partitions a first space and a second space and includes a plurality of regions capable of being controlled to a transmitting state in which light is transmitted or a light-shielding state in which light is shielded; alight-shielding and transmitting information generation unit that generates light-shielding and transmitting information for controlling the transmitting state or the light-shielding state of a position of each of the plurality of regions on the basis of information indicating a state of the vicinity of the light-shielding wall; and a control unit that controls the transmitting state or the light-shielding state of the plurality of regions of the light-shielding wall on the basis of the light-shielding and transmitting information generated by the light-shielding and transmitting information generation unit.

According to the aspects of the present disclosure, a first space and a second space are separated by a light-shielding wall including a plurality of regions capable of being controlled to a light-shielding state in which light is transmitted, or a light-shielding state in which light is shielded, light-shielding and transmitting information for controlling the transmitting state or the light-shielding state of a position of each of the plurality of regions is generated on the basis of information indicating a state of the vicinity of the light-shielding wall, and the transmitting state or the light-shielding state of the plurality of regions of the light-shielding wall is controlled on the basis of the light-shielding and transmitting information that is generated.

### Effects of the Invention

According to the aspects of the present disclosure, it is possible to make an object that is meant to be invisible enter a state in which the object is hidden so as to be invisible to eyes or is less likely to be visible to eyes, or to make an object that is meant to be visible enter a state in which the object is likely to be visible to eyes in correspondence with the state of the vicinity of the light-shielding wall.

### BRIEF DESCRIPTION OF DRAWINGS

FIG. 1 is a view illustrating an overview of a light-shielding device according to the present disclosure.

FIG. 2 is a view illustrating a light-shielding wall of the light-shielding device illustrated in FIG. 1.

FIG. 3 is a view illustrating the light-shielding wall of the light-shielding device illustrated in FIG. 1.

FIG. 4 is a view illustrating a configuration example of a first embodiment of the light-shielding device according to the present disclosure.

FIG. 5 is a block diagram illustrating a function of realizing the light-shielding device illustrated in FIG. 4.

FIG. 6 is a flowchart illustrating partial transmission processing by the light-shielding device illustrated in FIG. 5.

FIG. 7 is a view illustrating a configuration example of a second embodiment of the light-shielding device according to the present disclosure.

FIG. 8 is a block diagram illustrating a function of realizing the light-shielding device illustrated in FIG. 7.

FIG. 9 is a flowchart illustrating animal observation processing by the light-shielding device illustrated in FIG. 8.

FIG. 10 is a view illustrating a configuration example of a third embodiment of the light-shielding device according to the present disclosure.

FIG. 11 is a block diagram illustrating a function for realizing the light-shielding device illustrated in FIG. 10.

FIG. 12 is a flowchart illustrating floor partial transmission processing by the light-shielding device illustrated in FIG. 11.

FIG. 13 is a view illustrating a configuration example of a fourth embodiment of the light-shielding device according to the present disclosure.

FIG. 14 is a block diagram illustrating a function of realizing the light-shielding device illustrated in FIG. 13.

FIG. 15 is a flowchart illustrating security processing by the light-shielding device illustrated in FIG. 14.

FIG. 16 is a view illustrating a fifth embodiment of the light-shielding device of the present disclosure.

FIG. 17 is a view illustrating an operation of the light-shielding device illustrated in FIG. 16.

FIG. 18 is a view illustrating a configuration example of the light-shielding device illustrated in FIG. 16 and FIG. 17.

FIG. 19 is a flowchart illustrating road wall blind processing by the light-shielding device illustrated in FIG. 18.

FIG. 20 is a view illustrating a configuration example of a general-purpose personal computer.

### MODE FOR CARRYING OUT THE INVENTION

Preferred embodiments of the present disclosure will be described in detail with reference to the accompanying drawings. Furthermore, in this specification and the drawings, the same reference numeral will be given to constituent elements having substantially the same functional configuration, and redundant description will be omitted.

Hereinafter, modes (hereinafter, referred to as “embodiments”) for carrying out the invention will be described. Furthermore, description will be made in the following order.

1. Overview of Light-Shielding Device of Present Disclosure

2. First Embodiment (example in a case of using a light-shielding wall as an observation window)

3. Second Embodiment (example in a case of using the light-shielding wall as the observation window when the light-shielding wall is used as a boundary between a breeding room and an observation space)

4. Third Embodiment (example in a case of using the light-shielding wall as a floor of an observation room of a tower and the like)

5. Fourth Embodiment (example in a case of using the light-shielding wall as a security window)

6. Fifth Embodiment (example in a case of using the light-shielding wall as a road wall)

### 1. Overview of Light-Shielding Device of Present Disclosure

A light-shielding device of the present disclosure is configured to make an object that is meant to be invisible enter a state in which the object is hidden so as to be invisible to eyes or is less likely to be visible to eyes, or to make an object that is meant to be visible enter a state in which the object is likely to be visible to eyes in correspondence with a state of the vicinity of a light-shielding wall.

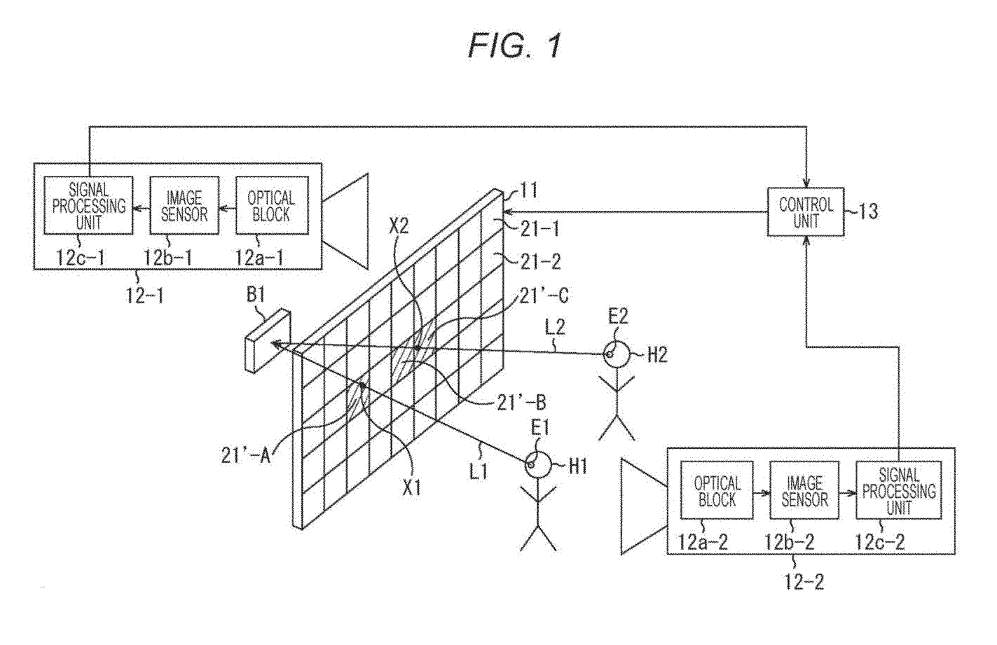

More specifically, as illustrated in FIG. 1, the light-shielding device of the present disclosure includes a light-shielding wall 11 that partitions a first space on the left in the drawing and a second space on the right in the drawing, and includes a plurality of panels 21 capable of being controlled to a light-shielding state, a transmitting state, or states of being changed to various transmittances. Furthermore, description will be made on the assumption that the panels 21 can be switched to any one state between two states of the light-shielding state and the transmitting state for explanation of an overview of the light-shielding device, and simplification of the explanation, but the panels 21 can also be controlled to states of being changed to various transmittances. Furthermore, the light-shielding state is a state of shielding light even at a part, the transmitting state is a state of transmitting incident light even at a part, and the light-shielding state may be a state in which a transmittance of incident light is lower in comparison to at least the transmitting state. Accordingly, for example, a transmittance of the panels 21 in the light-shielding state may be lower than a transmittance of a panel state in the transmitting state, and the transmittance of the light-shielding state may be 10% to 30% in addition to 0%, and the transmittance of the transmitting state may be 90% to 70% in addition to 100%.

For example, the light-shielding wall 11 controls only panels 21 in a region capable of directly viewing an object B1 that exists in the first space from visual points of persons H1 and H2 who exist in the second space in the light-shielding state, and controls panels 21 in the other regions in the transmitting state. That is, the light-shielding device illustrated in FIG. 1 makes an object, which is not meant to be visible, be invisible.

More specifically, the light-shielding device illustrated in FIG. 1 includes the light-shielding wall 11, cameras 12-1 and 12-2, and a control unit 13. The light-shielding wall 11 partitions the first space that is shown at the left portion in the drawing, and the second space that is shown at the right portion in the drawing. As illustrated in FIG. 1, in the first space, an object B1, which is not meant to be visible to the persons H1 and H2 in the second space (which is meant to be hidden in an invisible state), exists. On the other hand, in the second space, persons (for example, the persons H1 and H2, and the like) can freely move.

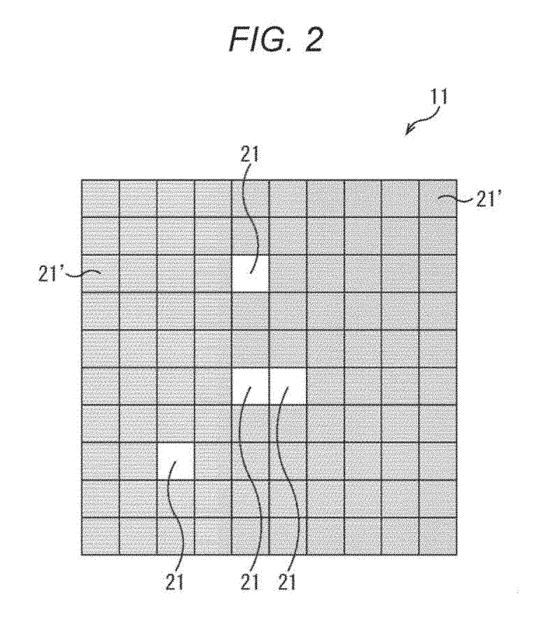

For example, as illustrated in FIG. 2, the light-shielding wall 11 includes a plurality of the panels 21. For example, each of the panels 21 is a liquid crystal panels having the size of approximately 10 cm×10 cm, and are controlled to the light-shielding state or the transmitting state by the control unit 13. However, the transmitting state includes states which are controlled to various transmittances. Furthermore, the size of the panel 21 is not limited to the size of approximately 10 cm×10 cm, and may be a size smaller than the size. In addition, FIG. 2 illustrates an example in which the panel 21 has a rectangular shape, but the panel 21 may not be the rectangular shape, and may be other shapes. The panel 21 may have a polygonal shape including a triangular shape, a circular shape, or other geometric figures. In addition, the panel 21 may have a configuration other than the liquid crystal panel as long as the panel 21 can be controlled to either a light-shielding state or the transmitting state capable of being controlled to various transmittances. Further, one sheet of the panel 21 may be divided into fine regions, and the regions may be controlled to individual transmittances. In other words, a minimum unit for controlling the light-shielding state or the transmitting state may be the panel 21 or the finely divided region. The minimum unit may be a panel unit or a region unit. However, in the embodiments of the present disclosure, description will be made on the assumption that the panel 21 is set as a control unit unless otherwise stated.

Furthermore, in FIG. 2, in a case where the panel 21 is in the light-shielding state, it is assumed that even when a person visually observes the panel 21 with naked eyes, it enters a state in which a person cannot recognize (view) an object that exists on an opposite side of the panel 21. In addition, in a case where the panel 21 is in the transmitting state, it is assumed that when the person visually observes the panel 21 with naked eyes, it enters a state in which the person can recognize (view) the object that exists on the opposite side of the panel 21. Furthermore, in FIG. 2, the panel 21 in the transmitting state is noted as “panel 21”, and the panel 21 in the light-shielding state is noted as “panel 21′”.

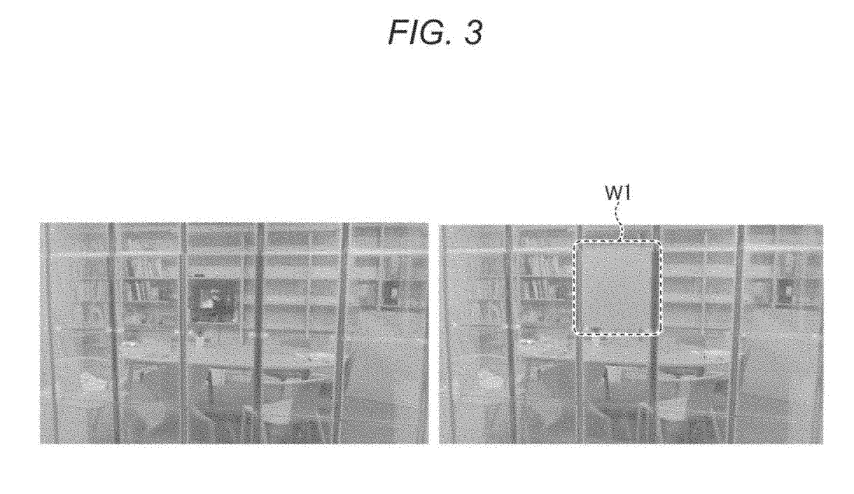

More specifically, for example, in a case where the light-shielding wall 11 exists on a front side, and a conference room exists on a rear side of the light-shielding wall 11, when the panels 21 are controlled to the light-shielding state, it enters a state in which the inside of the conference room is invisible (a state in which the inside cannot be visually recognized) as illustrated by the inside of a region W1 surrounded by a dot line at a right portion in FIG. 3. In addition, as illustrated by regions other than the region W1, when the panels 21 are controlled in the transmitting state, it enters a state in which the inside of the conference room is visible (a state in which the inside can be visually confirmed).

The cameras 12-1 and 12-2 capture an image of the first space and the second space, and supply the captured image to the control unit 13. Furthermore, in the following description, in a case where it is not necessary to particularly discriminate the cameras 12-1 and 12-2, it is assumed that the cameras 12-1 and 12-2 are referred to as simply as “camera 12”, and this is also true of other configurations. More specifically, the cameras 12-1 and 12-2 respectively include optical blocks 12a-1 and 12a-2, image sensors 12b-1 and 12b-2, and signal processing units 12c-1 and 12c-2. The optical block 12a includes at least one or more sheets of lenses and condenses light to focus the light to the image sensor 12b. The image sensor 12b converts the focused light that is incident through the optical block into a signal corresponding to a light quantity in a pixel unit that is disposed in an array shape, and outputs the signal to the signal processing unit 12c. The signal processing unit 12c performs predetermined signal processing with respect to signals supplied from respective pixels to generate an image constituted by pixel signals, and outputs the generated image to the control unit 13. Here, the cameras 12-1 and 12-2 respectively capture images, and capture images including distance data from the cameras 12-1 and 12-2 in a space in a subject image captured with respect to respective pixels. That is, the cameras 12-1 and 12-2 have a camera function that is so-called depth camera. According to this, the images captured by the cameras 12-1 and 12-2 include information distances from the camera 12-1 and 12-2 to the subject in a pixel unit in addition to a typical image. Furthermore, in the following description, it is assumed that an image constituted by distance information in a pixel unit is referred to as a distance image. Accordingly, the cameras 12-1 and 12-2 capture a typical image, generate the distance image, and supply the distance image to the control unit 13.

The control unit 13 includes a control circuit such as one or a plurality of central processing units (CPU), and acquires images of the first space and the second space which are respectively supplied from the cameras 12-1 and 12-2. The control unit 13 recognizes a position of the object B1 in the first space on the basis of the image of the first space, and information of an installation position and a direction of the camera 12-1. In addition, the control unit 13 specifies eye positions E1 and E2 of the persons H1 and H2 to whom the object B1 is not meant to be visible on the basis of the image of the second space and information of an installation position and a direction of the camera 12-2. Further, the control unit 13 acquires optical paths L1 and L2 of the object B1 from the eye positions E1 and E2 of the persons H1 and H2 to whom the object B1 is not meant to be visible. The optical paths L1 and L2 may be also be referred to as paths of visual lines when visually observing the object B1 from the eye positions E1 and E2 of the persons H1 and H2 to whom the object B1 is not meant to be visible.

In addition, the control unit 13 controls panels 21 including intersections with the optical paths L1 and L2 among the panels 21 on the light-shielding wall 11 to the light-shielding state, and controls the other panels 21 to the transmitting state. According to the control, it is possible to maintain the second space as a bright and spacious space while maintaining the object B1 that exists in the first space in an invisible state with respect to the persons H1 and H2 who are in the second space. That is, for example, the transmitting state becomes a state in which a room on the other side is visible over the light-shielding wall 11 as illustrated at a left portion in FIG. 3. On the other hand, the light-shielding state is a state in which the room on the other side is invisible as indicated by the region W1 at a left portion in FIG. 3.

Furthermore, in FIG. 1, the optical paths express visual lines when the eye positions E1 and E2 of the persons H1 and H2 are set as visual points, but the optical paths may represent paths of light that is transmitted through or shielded by the light-shielding wall 11. Accordingly, the optical paths may not express the visual lines, and for example, a path that represents a route of sunlight of which a light source is the sun is also called an optical path. Here, in the following description, it is assumed that routes of light, which is transmitted through the light-shielding wall 11 when the respective panels 21 of the light-shielding wall 11 is controlled to the transmitting state, are referred to as “optical path”.

In addition, in a state in which a position of the object B1 in a space can be recognized in advance, the camera 12-1 is not particularly necessary, and a configuration including only the camera 12-2 may be employed. In addition, in the case of the sunlight of which a light source is the sun, the sunlight can be regarded as being approximately parallel on the earth, and an optical path can be obtained if an azimuth and a direction of the light-shielding wall 11 can be recognized. Accordingly, even in this case, a configuration including only the camera 12-2 may be employed.

Further, description has been given of an example in which a panel 21 on an optical path, on which an object meant to be invisible to a predetermined user through the light-shielding wall 11 is visible, is set to the light-shielding state, and the other panels 21 are set to the transmitting state. However, in contrast to the example, in a case where an object, which may be visible to a predetermined user through the light-shielding wall 11 but is meant to be invisible to users other than the predetermined user, exists, only a panel 21 on an optical path from the predetermined user to the object may be set to the transmitting state, and the other panels 21 may be set to the light-shielding state.

### 2. First Embodiment

### Example of Light-Shielding Device Allowing Only User Close to Light-Shielding Wall to Visually Confirm Outside of Light-Shielding Wall

The above-described light-shielding wall 11 can be used like window glass when the panels 21 are set to the transmitting state, and can be allowed to function as a blind when the panels 21 are set to the light-shielding state. Here, in the first embodiment of the light-shielding device to which the technology of the present disclosure is applied, description will be given of an example in which the above-described light-shielding wall 11 is used as a window.

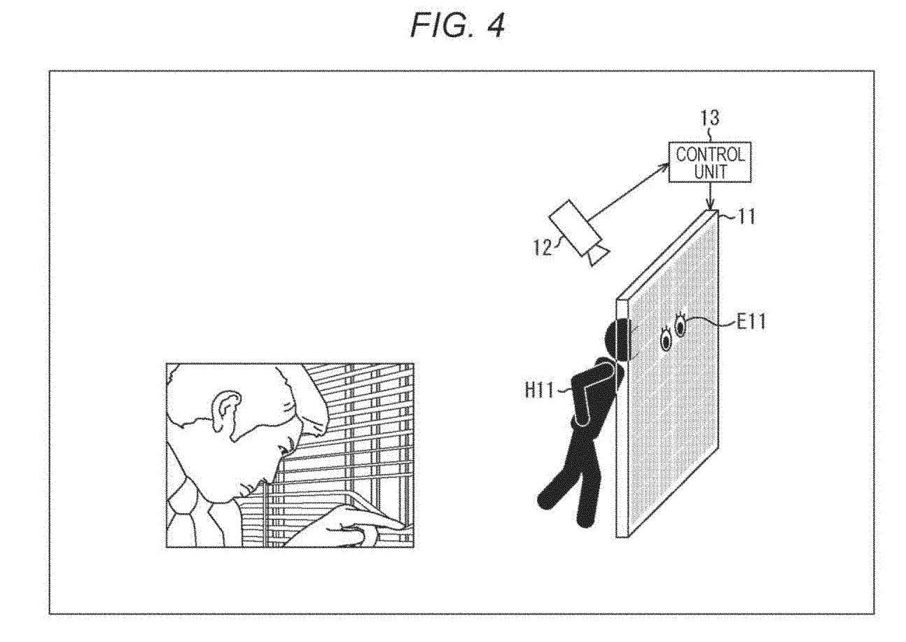

FIG. 4 illustrates a configuration example of the light-shielding device in which the light-shielding wall 11 is used as window glass, panels 21 in a predetermined range in the light-shielding wall 11 are controlled to the transmitting state, and panels 21 in a range other than the predetermined range are controlled to the light-shielding state in correspondence with a state corresponding to a positional relationship between the light-shielding wall 11 as the window and a specific portion of a user in the vicinity of the light-shielding wall 11.

Furthermore, the light-shielding device illustrated in FIG. 4 can be used as a window by setting the respective panels 21 of the light-shielding wall 11 to the transmitting state. In addition, the light-shielding device can be allowed to function as a blind by changing a transmittance even in the light-shielding state or the transmitting state.

More specifically, the camera 12 in the light-shielding device illustrated in FIG. 4 captures an image of an interior in which a user H11 exists, and supplies the captured image to the control unit 13. The control unit 13 estimates a position of eyes as the specific portion of the user H11 on the basis of the captured image.

Then, with regard to the window that is constituted by the light-shielding wall 11, as illustrated at a right portion in FIG. 4, in a case where the position of eyes as the specific portion exists in the vicinity of the light-shielding wall 11 (in a case approaching the light-shielding wall 11), the control unit 13 controls panels 21 in a region E11 of the light-shielding wall 11 corresponding to the position of eyes as the specific portion to the transmitting state.

According to the processing, for example, as illustrated on a left portion in FIG. 4, in a case where a blind is used in the light-shielding state, it is not necessary to perform an action of bending a slat of the blind (a wing of the blind) with a finer and the like to make a space, and of peeking through the space to see an outer side.

### Configuration Example of Realizing Light-Shielding Device Illustrated in FIG. 4

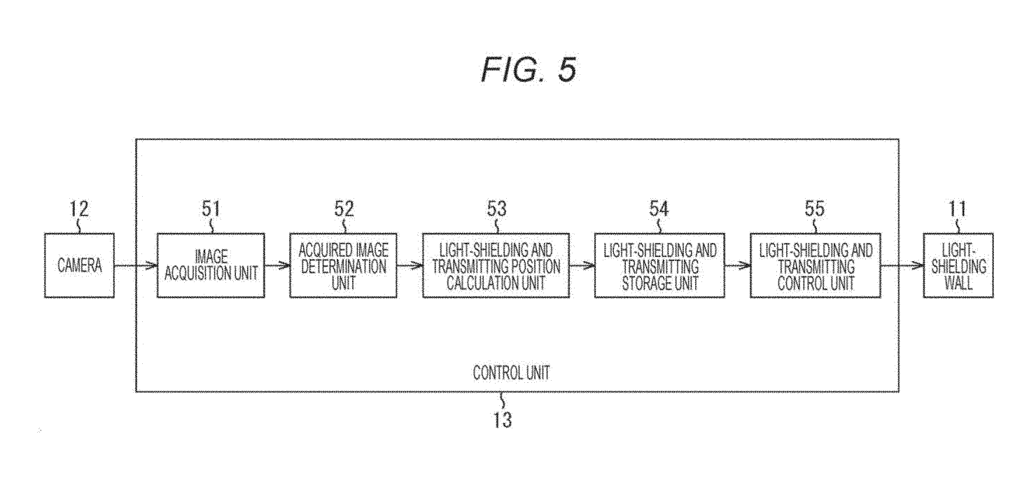

Next, a detailed configuration for realizing the light-shielding device illustrated in FIG. 4 will be described with reference to a block diagram in FIG. 5. Furthermore, the light-shielding wall 11 and the camera 12 which constitute the window have the same function as the function described with reference to FIG. 1 to FIG. 3, and thus description thereof will be appropriately omitted.

The control unit 13 includes an image acquisition unit 51, an acquired image determination unit 52, a light-shielding and transmitting position calculation unit 53, a light-shielding and transmitting storage unit 54, and alight-shielding and transmitting control unit 55.

The image acquisition unit 51 acquires a depth image obtained by capturing an image of an interior of a room, in which the light-shielding wall 11 is provided as a window and in which a user is present, by the camera 12, and supplies the depth image to the acquired image determination unit 52.

The acquired image determination unit 52 analyzes the depth image supplied from the image acquisition unit 51, and detects presence or absence of the user in the depth image. In a case where the user is present, the acquired image determination unit 52 estimates a position of user'eyes, and further supplies information of the estimated position of the eyes to the light-shielding and transmitting position calculation unit 53 in a case where the estimated position of the eyes is closer to the light-shielding wall 11 in comparison to a predetermined distance (is present in the vicinity of the light-shielding wall 11).

The light-shielding and transmitting position calculation unit 53 specifies a position of a corresponding panel 21 in the light-shielding wall 11 on the basis of the information of the position of eyes which is supplied from the acquired image determination unit 52, generates light-shielding and transmitting information for controlling the specified panel 21 to the transmitting state and for controlling the other panels 21 to the light-shielding state, and storages the information in the light-shielding and transmitting storage unit 54.

The light-shielding and transmitting information is information in which the respective panels 21 are set and registered to either the light-shielding state or the transmitting state, and a transmittance in the transmitting state is set and registered. Accordingly, in the light-shielding and transmitting information, information related to setting to either the light-shielding state or the transmitting state of the respective panels 21, and a transmittance of the panels 21 set to the transmitting state are set by the light-shielding and transmitting position calculation unit 53. Furthermore, the transmittance in a case of being controlled to the transmitting sate is assumed as “1”, but the other transmittances may be set. In addition, each of the panels 21 may be divided into fine regions, and the regions may be controlled to either the light-shielding state or the transmitting state. In this case, the light-shielding and transmitting information becomes information indicating that the regions will be set to which state between the light-shielding state and the transmitting state. In addition, the information registered as the light-shielding and transmitting information may be information indicating a transmittance or a light-shielding rate which corresponds to information indicating that setting will be made to which state between the light-shielding state and the transmitting state. For example, the transmittance may be set as “1—light-shielding rate”.

The light-shielding and transmitting control unit 55 controls the light-shielding state and the transmitting state that considers the transmittance, of the respective panels 21 of the light-shielding wall 11 in correspondence with the light-shielding and transmitting information which is stored in the light-shielding and transmitting storage unit 54 and in which information of the transmitting state or the light-shielding state of the respective panels 21 in the light-shielding wall 11, and information of each transmittance of transmitting panels 21 are registered.

### Partial Transmission Processing by Light-Shielding Device Illustrated in FIG. 5

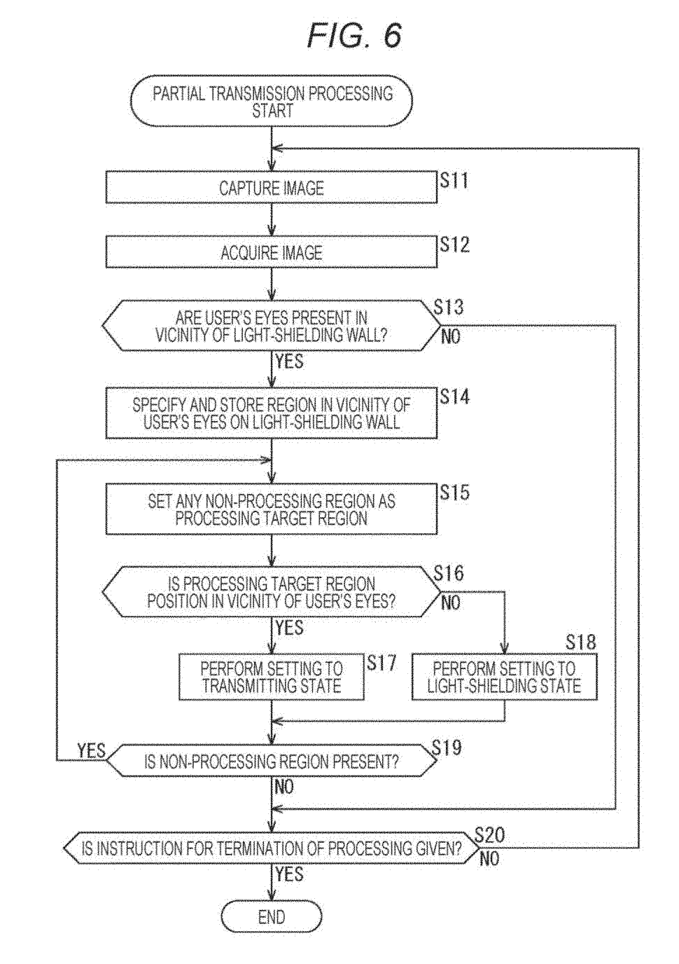

Next, partial transmission processing in the control unit 13 of the light-shielding device illustrated in FIG. 5 will be described with reference to a flowchart in FIG. 6.

In step S11, the camera 12 captures an image of an interior side of the window that is constituted by the light-shielding wall 11 as a depth image, and supplies the depth image to the image acquisition unit 51.

In step S12, the image acquisition unit 51 supplies the depth image supplied from the camera 12 to the acquired image determination unit 52.

In step S13, the acquired image determination unit 52 detects user's eyes as a specific position of the user from the depth image, specifies a spatial position, determines whether or not the user's eyes are present in the vicinity of the light-shielding wall 11 in accordance with whether or not the position in a space is a position closer to the light-shielding wall 11 in comparison to a predetermined distance, and supplies the determination result to the light-shielding and transmitting position calculation unit 53.

More specifically, the acquired image determination unit 52 performs face image detection processing with respect to the depth image to detect the face image. In addition, the acquired image determination unit 52 performs organ extraction of the eyes from the detected face image. Further, the acquired image determination unit 52 calculates a spatial position on an interior side of the window that is constituted by the light-shielding wall 11 on the basis of distance information of the eyes as an extracted organ in the depth image, specifies a position of the user's eyes, and determines whether or not the user's eyes of the user are present in the vicinity of the light-shielding wall 11 on the basis of whether or not the user's eyes are within a predetermined distance from the light-shielding wall 11. Furthermore, in a case where the face image is not present in the image captured by the camera 12, for example, in a case where only an image of an occipital portion and the like is captured, the acquired image determination unit 52 may extract the image of the occipital portion instead of the face image to estimate the position of the eyes from a position of the image of the occipital portion. In addition, in a case of capturing a moving image and the like, the acquired image determination unit 52 may detect the face image from a scene image in which the face image is captured, may continuously track a position of detected eyes, and may estimate the position of eyes even in a scene in which the face image is not present, for example, a scene in which only the occipital portion is shown.

In step S13, for example, in a case where it is determined that the user's eyes are closer to the light-shielding wall 11 than a predetermined distance, the acquired image determination unit 52 supplies position information of the user's eyes to the light-shielding and transmitting position calculation unit 53 in combination with the determination result, and the processing proceeds to step S14.

In step S14, the light-shielding and transmitting position calculation unit 53 stores spatial position information of the user's eyes as the specific portion of the user.

In step S15, the light-shielding and transmitting position calculation unit 53 sets any non-processing region in predetermined regions which are set in a unit of each panel 21 in the light-shielding wall 11 as a processing handling region.

In step S16, the light-shielding and transmitting position calculation unit 53 determines whether or not a position of the panel 21 in a processing target region is near the spatial position of the user's eyes as the specific portion of the user. In step S16, in a case where it is determined that the position of the panel 21 in the processing target region is near the spatial position of the user's eyes as the specific portion of the user, the processing proceeds to step S17.

In step S17, the light-shielding and transmitting position calculation unit 53 stores light-shielding and transmitting information for controlling the panel 21 in the processing target region to the transmitting state in the light-shielding and transmitting storage unit 54. In correspondence with the processing, the light-shielding and transmitting control unit 55 controls the panel 21 in the processing target region to the transmitting state on the basis of the light-shielding and transmitting information stored in the light-shielding and transmitting storage unit 54.

On the other hand, in step S16, in a case where it is determined that the position of the panel 21 in the processing target region is not near the spatial position of the user's eyes as the specific portion of the user, the processing proceeds to step S18.

In step S18, the light-shielding and transmitting position calculation unit 53 stores light-shielding and transmitting information for controlling the panel 21 in the processing target region to the light-shielding state in the light-shielding and transmitting storage unit 54. In correspondence with the processing, the light-shielding and transmitting control unit 55 controls the panel 21 in the processing target region to the light-shielding state on the basis of the light-shielding and transmitting information stored in the light-shielding and transmitting storage unit 54.

In step S19, the light-shielding and transmitting position calculation unit 53 determines whether or not a non-processing region exists among regions set in a unit of each panel 21 in the light-shielding wall 11, and in a case where it is determined that the non-processing region exists, the processing returns to step S15. That is, the processing from step S15 to step S19 is repeated until the non-processing region disappears. Then, in step S19, in a case where it is determined that the non-processing region does not exist, the processing proceeds to step S20. Furthermore, in step S13, in a case where it is determined that the user's eyes are not closer to the light-shielding wall 11 than the predetermine distance, the processing in steps S14 to S19 is skipped.

In step S20, the acquired image determination unit 52 determines whether or not an instruction for termination of the processing is given, and in a case where it is determined that the instruction for termination of the processing is not given, the processing returns to step S11, and the subsequent processing is repeated. Then, in step S20, in a case where it is determined that the instruction for termination of the processing is given, the processing is terminated.

That is, according to the above-described processing, as illustrated at a right portion in FIG. 4, when the user's eyes approach to the window constituted by the light-shielding wall 11, a panel 21 at a position corresponding to the approaching eyes is controlled to the transmitting state, and the other panels 21 are controlled to the light-shielding state. In a state other than the above-described state, the entirety of the panels 21 are controlled to the light-shielding state.

Accordingly, the entirety of the panels 21 are controlled to the light-shielding state until the user's eyes approach the panels 21. Accordingly, a state on the interior side of the window constituted by the light-shielding wall 11 in which the user exists becomes a state of being invisible from the exterior, and thus privacy of the interior in which the user exists can be kept. In addition, in a case where the user in the interior desires to view an outer side of the window constituted by the light-shielding wall 11 while maintaining the state in which privacy is kept, when eyes approach light-shielding wall 11, the panel 21 in the vicinity of the eyes is controlled to the transmitting state. Accordingly, it is possible to peek through the panel 21 to confirm an exterior state.

Furthermore, description has been given of an example in which the position of the user's eyes is specified by using the depth image captured by the camera 12, but the position of the eyes may be specified by using a two-dimensional image. In addition, even in a case where a face or eyes are not shown on an image captured by the camera 12, an image such a moving image that is continuously captured may be used and movement of the eyes may be tracked from the image on which eyes are shown to estimate a position of the eyes on the image on which the face or the eyes are not shown.

Further, with regard to the position of the eyes approaching the window constituted by the light-shielding wall 11, the position may be detected by configurations other than the depth image captured by the camera 12 or a typical two-dimensional image. For example, the position of the eyes may be specified in a stage until approaching the light-shielding wall 11, and whether or not the position is within a predetermined distance may be determined, for example, by using an infrared sensor and the like.

In addition, description has been given of an example in which the user exists in the interior. However, when the user exists in the exterior and peeking through the light-shielding wall 11 from the exterior, a panel 21 in a region corresponding to a position of the eyes may be controlled to the transmitting state and the other panels 21 may be controlled to the light-shielding state to allow the user to peek through the panel 21 to see the interior from the exterior. However, in this case, it is necessary for the camera 12 to be configured to capture an image of the exterior.

### 3. Second Embodiment

Description has been given of an example in which the light-shielding wall 11 is applied as the window, and on the basis of a peripheral state of the window constituted by the light-shielding wall 11, when the user's eyes are in the vicinity of the light-shielding wall 11 and approach the light-shielding wall 11 within a predetermined distance, a panel 21 in a region corresponding to the position of the eyes is controlled to the transmitting state and panels 21 in the other regions are controlled to the light-shielding state. However, in the example, it is assumed that the light-shielding wall 11 is controlled to the light-shielding state as a whole, and thus a state on an outer side of the window constituted by the light-shielding wall 11 cannot be seen.

Accordingly, for example, when considering that the window constituted by the light-shielding wall 11 is used as a boundary between a breeding room of an animal that is an observation target in a zoo, and a space for observation (hereinafter, also referred to as an observation space) of a visitor of the zoo, the window constituted by the light-shielding wall 11 is always set to the light-shielding state, and it is necessary for the visitor to approach the window constituted by the light-shielding wall 11 to make eyes be close to the light-shielding wall 11 so as to view the animal inside the breeding room. In this case, it is difficult for a lot of visitors to observe the animal simultaneously.

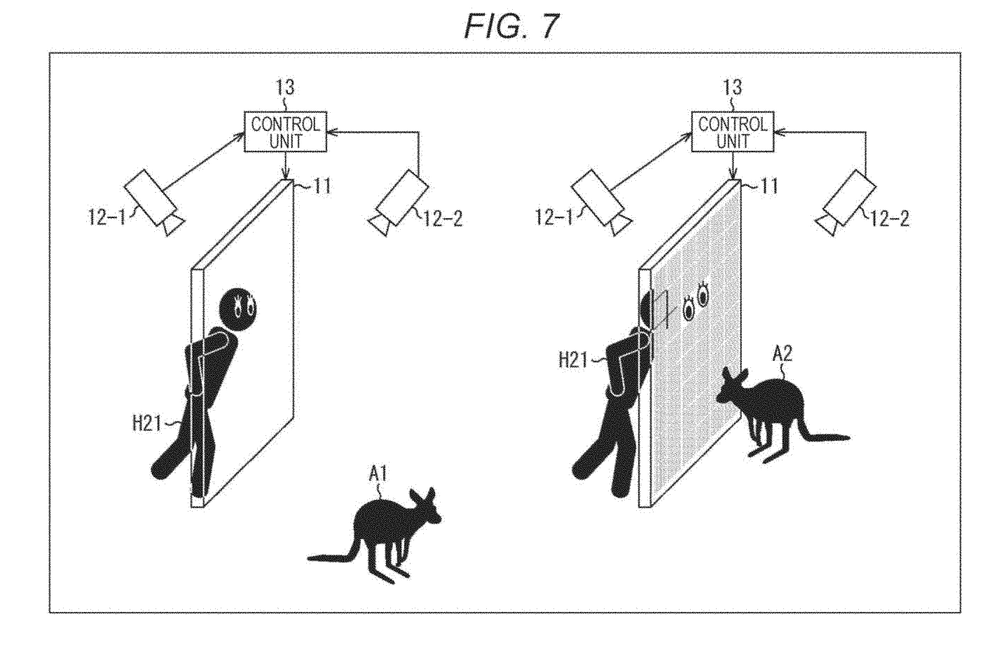

Here, in a case of constructing the boundary between the breeding room and the observation space by using the window constituted by the light-shielding wall 11, as in a light-shielding device illustrated in FIG. 7, cameras 12-1 and 12-2 which respectively capture images of the breeding room and the observation space are provided. Then, as indicated by an animal A1 inside the breeding room at a left portion in FIG. 7, in a case where the animal A1 stands with its back to the light-shielding wall 11 and cannot view the light-shielding wall 11, the control unit 13 controls the entirety of the light-shielding wall 11 to the transmitting state. On the other hand, as indicated by an animal A2 inside the breeding room at a right portion in FIG. 7, in a case where the animal A2 faces the light-shielding wall 11, the control unit 13 may set the light-shielding wall 11 to the above-described partial transmission processing.

According to the configuration, in the breeding room in a zoo, for example, even in a case where an animal which is afraid of human beings and the like are bred, in a case where the animal views the window constituted by the light-shielding wall 11, control is made to the light-shielding state, and thus it is possible to realize a state in which the animal that is bred is not aware of eyes of a visitor. In addition, when the visitor approaches the light-shielding wall 11 to make eyes close thereto, only a panel 21 near the eyes is controlled to the transmitting state, and thus the visitor can observe the animal without surprising the animal. In addition, in a case where the animal does not view the window constituted by the light-shielding wall 11, the entirety of the panels 21 of the light-shielding wall 11 are controlled to the transmitting state, and thus a lot of visitors can simultaneously observe the animal inside the breeding room. In any case, the panels 21 of the light-shielding wall 11 can be controlled to the light-shielding state or the transmitting state on the basis of a state between the animal and the light-shielding wall 11, and thus a lot of visitors can simultaneously observe the animal in correspondence with the state without surprising the animal.

### Configuration Example for Realizing Light-Shielding Device Illustrated in FIG. 7

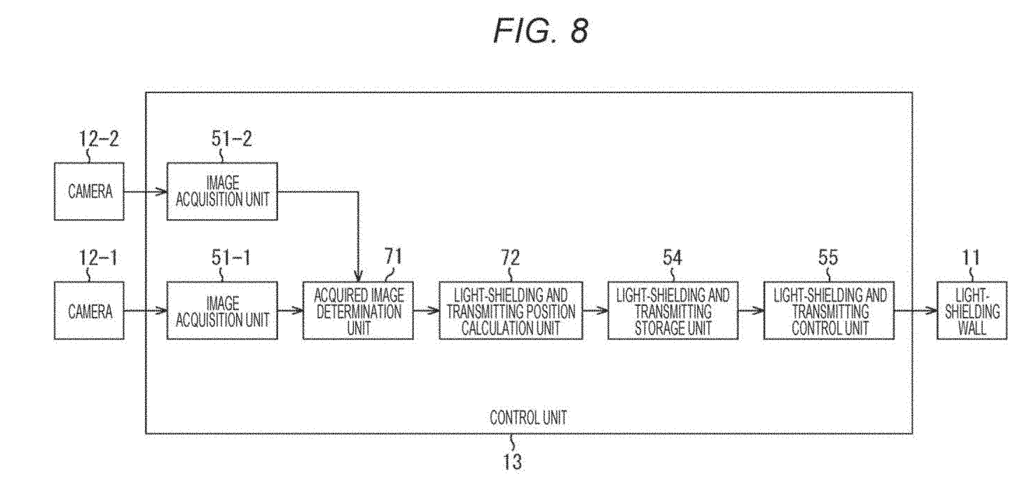

A detailed configuration for realizing the light-shielding device illustrated in FIG. 7 will be described with reference to a block diagram in FIG. 8. Furthermore, the light-shielding wall 11 and the camera 12 which constitute the window have the same function as described with reference to FIG. 1 to FIG. 3, and thus description thereof will be appropriately omitted. In addition, in the configuration illustrated in FIG. 8, the same reference numeral and the same terminology will be given to a configuration having the same function as that of the configuration in FIG. 5, and description thereof will be appropriately omitted.

Specifically, the light-shielding device illustrated in FIG. 8 is different from the light-shielding device illustrated in FIG. 5 in that the camera 12 includes cameras 12-1 and 12-2, image acquisition units 51-1 and 51-2 are respectively provided in the cameras 12-1 and 12-2, and an acquired image determination unit 71 and a light-shielding and transmitting position calculation unit 72 are further provided instead of the acquired image determination unit 52 and the light-shielding and transmitting position calculation unit 53.

The cameras 12-1 and 12-2, and image acquisition units 51-1 and 51-2 are the same as the camera 12 and the image acquisition unit 51, but the camera 12-1 captures an image of the observation space, and the camera 12-2 captures an image inside the breeding room.

In addition, the acquired image determination unit 71 executes processing that is basically similar to the processing in the acquired image determination unit 52, but the acquired image determination unit 71 further determines a state of the animal inside the breeding room, and supplies the determination result to the light-shielding and transmitting position calculation unit 72. That is, the acquired image determination unit 71 determines whether or not it is a state in which the light-shielding wall 11 exists in a visual field of the animal inside the breeding room (a state in which a visitor is visible through the window constituted by the light-shielding wall 11) on the basis of an image inside the breeding room which is captured by the camera 12-2 and is supplied from the image acquisition unit 51-2, and supplies the determination result to the light-shielding and transmitting position calculation unit 72.

The light-shielding and transmitting position calculation unit 72 executes processing that is basically similar to the processing in the light-shielding and transmitting position calculation unit 53, but executes processing corresponding to the determination result as to whether or not it is a state in which the light-shielding wall 11 exists in the visual field of the animal inside the breeding room (a state in which the visitor is visible through the window constituted by the light-shielding wall 11).

That is, in a case where a determination is made as the state in which the light-shielding wall 11 is included in the visual field of the animal inside the breeding room on the basis of the image inside the breeding room which is captured by the camera 12-2 (in a case where a determination result indicating the state in which the visitor is visible through the window constituted by the light-shielding wall 11 is supplied), when the image captured by the camera 12-1 is supplied from the image acquisition unit 51-1, in the light-shielding and transmitting position calculation unit 72, the acquired image determination unit 71 execute processing similar to the partial transmission processing.

In addition, when being supplied with a determination result indicating a state in which the visitor is not included the visual field of the animal inside the breeding room through the window constituted by the light-shielding wall 11 on the basis of the image inside the breeding room which is captured by the camera 12-2, the light-shielding and transmitting position calculation unit 72 controls the entirety of the panels 21 of the light-shielding wall 11 to the transmitting state.

### Partial Transmission Processing by Light-Shielding Device Illustrated in FIG. 8

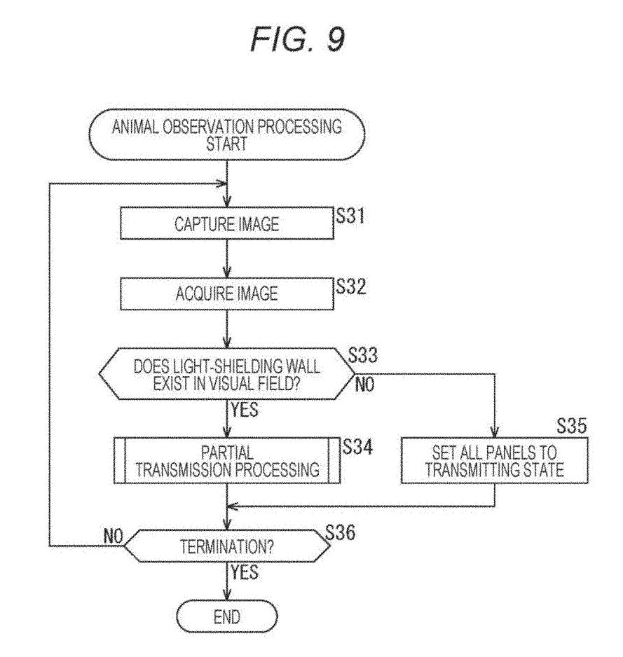

Next, observation processing in the control unit 13 of the light-shielding device illustrated in FIG. 8 will be described with reference to a flowchart in FIG. 9. Here, description will be given of a case where an animal is set as an observation target as an example, but the observation target may be a living being, a nonliving thing on which a camera is mounted, or the like.

In step S31, the camera 12-2 captures an image of a breeding room side of the window constituted by the light-shielding wall 11 as a depth image, and supplies the depth image to the image acquisition unit 51-2.

In step S32, the image acquisition unit 51-2 supplies the depth image supplied from the camera 12-2 to the acquired image determination unit 71.

In step S33, the acquired image determination unit 71 detects a face as a specific portion of the animal from the depth image inside the breeding room, specifies a position in the breeding room, determines whether or not the light-shielding wall 11 exists in a visual field of the animal, and supplies the determination result to the light-shielding and transmitting position calculation unit 72.

More specifically, the acquired image determination unit 71 performs an animal face image detection processing with respect to the depth image to detect an animal face image. In addition, the acquired image determination unit 71 performs organ extraction of eyes from the detected face image. Further, the acquired image determination unit 71 determines whether or not the window constituted by the light-shielding wall 11 is in the visual field of the animal inside the breeding room on the basis of distance information of the eyes as the extracted organ within the depth image.

In step S33, for example, in a case where the window constituted by the light-shielding wall 11 exists in the visual field of the eyes of the animal inside the breeding room, and the animal can visually recognize a visitor, the processing proceeds to step S34.

In step S34, the light-shielding and transmitting position calculation unit 72 executes the above-described partial transmission processing in correspondence with the determination result of the acquired image determination unit 71 which is based on the image transmitted from the image acquisition unit 51-1 that acquires the image captured by the camera 12-1. Furthermore, the partial transmission processing in step S34 is a series of processing including steps S11 to S19 in FIG. 6, and is similar to the processing described above, and thus description thereof will be omitted.

That is, in the present instance, in a state in which the window constituted by the light-shielding wall 11 exists in the visual field of the animal inside the breeding room, and the visitor is visible to the animal through the window, an animal that is afraid of human beings cannot take a stable action, and thus there is a concern that it is difficult to observe an action intrinsic to the animal. Here, in this case, the entirety of the light-shielding wall 11 is set to the light-shielding state, and when a visitor make eyes close to the light-shielding wall 11, apart corresponding to the eyes is set to the transmitting state through the partial transmission processing so as to allow the visitor to observe the animal inside the breeding room like a peek. Accordingly, it is possible to establish a state capable of appropriately observing an action intrinsic to the animal without surprising the animal inside the breeding room.

On the other hand, in step S33, for example, in a case where the window constituted by the light-shielding wall 11 does not exist in a visual field of eyes of the animal inside the breeding room, and the visitor is not visible to the animal through the window, the processing proceeds to step S35.

In step S35, the light-shielding and transmitting position calculation unit 72 controls the entirety of the panels 21 of the light-shielding wall 11 to the transmitting state on the basis of the determination result.

That is, in the present instance, in a state in which the window constituted by the light-shielding wall 11 does not exist in the visual field of the animal inside the breeding room, and the visitor is invisible to the animal through the window, an animal that is afraid of human beings can take an action without concerning a visual line of the visitor. Here, in this case, the entirety of the panels 21 of the light-shielding wall 11 are controlled to the transmitting state. Accordingly, even in a case where the visitor is spaced away from the window constituted by the light-shielding wall 11, the visitor can observe the animal inside the breeding room, and thus a plurality of the visitors can simultaneously observe the animal. Furthermore, in step S35, the control unit 13 may perform processing of setting a lot of regions greater than at least the regions, which are controlled to the transmitting state through the partial transmission processing, to the transmitting state although all regions are not set to the transmitting state.

In step S36, the acquired image determination unit 71 determines whether or not an instruction for termination of the processing is given, and in a case where it is determined that the instruction for termination of the processing is not given, the processing returns to step S31, and the subsequent processing is repeated. Then, in step S36, in a case where it is determined that the instruction for termination of the processing is given, the processing is terminated.

That is, according to the above-described processing, as indicated by the animal A1 at the left portion in FIG. 7, in a state in which the animal A1 does not view the window constituted by the light-shielding wall 11, and an observation aspect of the visitor is invisible to the animal A1 through the window constituted by the light-shielding wall 11, the entirety of the panels 21 of the light-shielding wall 11 are set to the transmitting state, and thus the visitor can observe an activity intrinsic to the animal without threatening the animal A1 inside the breeding room even from a position distant from the light-shielding wall 11.

In addition, as indicated by the animal A2 at the right portion in FIG. 7, in a state in which the animal A2 views the window constituted by the light-shielding wall 11, and the visitor is visible to the animal A2 through the window constituted by the light-shielding wall 11, the above-described partial transmission processing is executed. According to this, only a visitor who makes eyes close to the light-shielding wall 11 can observe the animal by controlling only a partial panel 21 corresponding to the eyes close to the light-shielding wall 11 to the transmitting state. In this case, a portion corresponding to the eyes of the visitor is controlled to the transmitting state, and thus the aspect of the visitor is invisible to the animal A2. Accordingly, it is possible to appropriately observe an action intrinsic to the animal without surprising the animal.

Furthermore, description has been given of an example in which the light-shielding wall 11 is subjected to the partial transmission processing or the entirety of the panels 21 are controlled to the transmitting state in correspondence with whether or not the animal views the window constituted by the light-shielding wall 11. However, the visitor may be invisible to the animal inside the breeding room through the window constituted by the light-shielding wall 11. In addition to a case where the window constituted by the light-shielding wall 11 exists in a visual field of the animal, when the window is spaced away from the animal by a predetermined distance, even in a case where the window exists in the visual field, the visitor is invisible to the animal through the window constituted by the light-shielding wall 11. Accordingly, the entirety of the panels 21 of the light-shielding wall 11 may be controlled to the transmitting state as long as the window is confirmed to be further spaced away in comparison to the predetermined distance in addition to whether or not the window constituted by the light-shielding wall 11 exists in the visual field of the animal.

In addition, in a case where a plurality of animals exist inside the breeding room, the entirety of the panels 21 may be controlled to the transmitting state only when the window constituted by the light-shielding wall 11 does not exist in a visual field of any of the plurality of animals, and the partial transmission processing may be performed in other cases.

### 4. Third Embodiment

Description has been given of an example in which the light-shielding wall 11 is applied to the window at the boundary between the observation space and the breeding room, the entirety of the panels 21 are set to the transmitting state in a case where the window constituted by the light-shielding wall 11 does not exist in a visual field of an animal inside the breeding room, and the partial transmission processing is performed in the other cases. However, the light-shielding wall 11 may be used as a floor instead of the window, and the transmitting state or the light-shielding state may be controlled in correspondence with a state of a user on the floor.

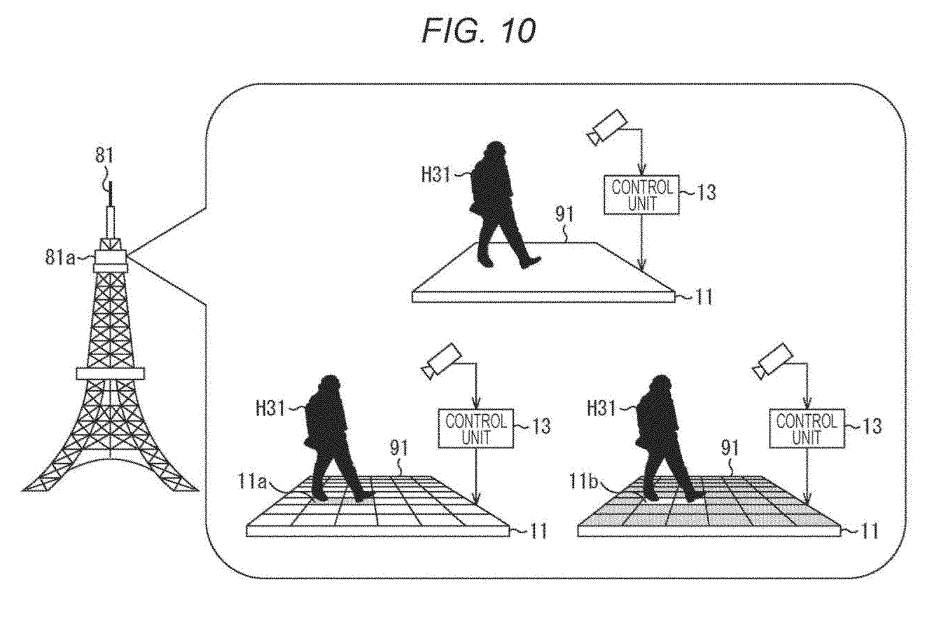

FIG. 10 illustrates an example of a light-shielding device in which the light-shielding wall 11 is used as a floor, and in which the panels 21 are controlled to the transmitting state or the light-shielding state in correspondence with a state of a user on the floor.

Specifically, as illustrated at a left portion in FIG. 10, the light-shielding device illustrated in FIG. 10 has a configuration in which a floor 91 of an observation room 81a of a tower 81 for touring is constituted by the light-shielding wall 11. As illustrated at an upper-right portion in FIG. 10, the respective panels 21 are controlled to either the light-shielding state or the transmitting state in correspondence with a state of a user on the light-shielding wall 11 as the floor.

More specifically, as illustrated at a lower-left portion of a right portion in FIG. 10, the camera 12 captures an image on the floor 91 constituted by the light-shielding wall 11 in the observation room 81a, the control unit 13 controls a panel 21 in a region 11a which a visitor (user) H31 newly enters to the light-shielding state on the basis of the captured image, and controls the other panels 21 to the transmitting state.

In addition, a condition of the light-shielding state and a condition of the transmitting state may be reversed. For example, as illustrated at a lower-right portion of the right portion in FIG. 10, the camera 12 captures an image on the floor 91 constituted by the light-shielding wall 11 inside the observation room 81a, and the control unit 13 controls a panel 21 in a region 11b which the visitor (user) H31 newly enters to the transmitting state on the basis of the captured image, and controls the other panels 21 to the light-shielding state.

According to the configuration, whenever the visitor H31 who is the user of the observation room 81a moves on the floor 91, due to direction in which only a portion under a foot of the visitor H31 is controlled to either the light-shielding state or the transmitting sate, it is possible to allow the visitor H31 to have various fine views.

### Configuration Example for Realizing Light-Shielding Device Illustrated in FIG. 10

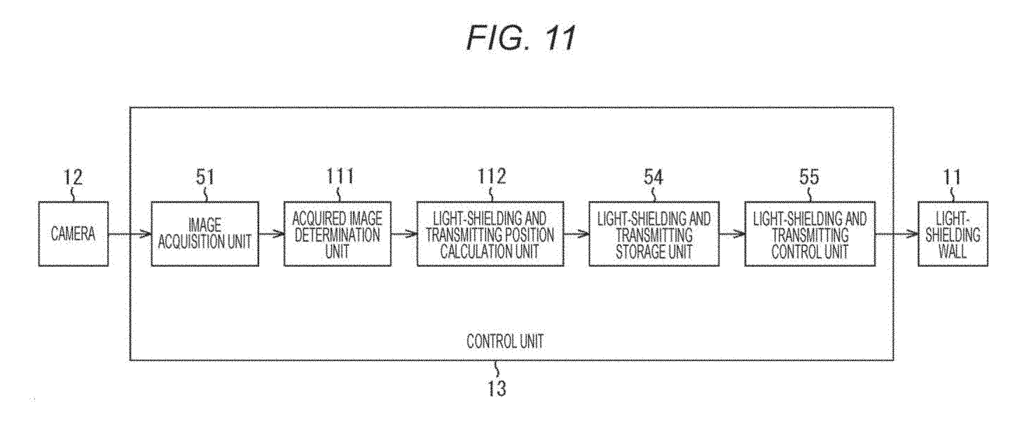

Next, a detailed configuration for realizing the light-shielding device illustrated in FIG. 10 will be described with reference to a block diagram in FIG. 11. Furthermore, the light-shielding wall 11 and the camera 12 which constitute the floor 91 have the same function as described with reference to FIG. 1 to FIG. 3, and thus description thereof will be appropriately omitted. In addition, in the configuration in FIG. 11, the same reference numeral and the same terminology will be given to a configuration having the same function as that of the configuration in FIG. 5, and description thereof will be appropriately omitted.

Specifically, the light-shielding device illustrated in FIG. 11 is different from the light-shielding device illustrated in FIG. 5 in that an acquired image determination unit 111 and a light-shielding and transmitting position calculation unit 112 are provided instead of the acquired image determination unit 52 and the light-shielding and transmitting position calculation unit 53.

In addition, the acquired image determination unit 111 specifies a stepped position of a foot of the visitor who is the user on the floor 91 in the observation room 81a in the image on the basis of a depth image that is supplied from the image acquisition unit 51, further, specifies a spatial position of the stepping foot inside the observation room 81a on the basis of distance information of the depth image, and supplies the specified positions to the light-shielding and transmitting position calculation unit 112.

The light-shielding and transmitting position calculation unit 112 specifies a panel 21, which corresponds to the spatial position of the foot inside the observation room 81a, on the light-shielding wall 11 that constitutes the floor 91 of the observation room 81a, generates transmitting and light-shielding information to control the specified panel 21 to the light-shielding state or the transmitting state, and to control the other panels 21 to the transmitting state or the light-shielding state, and stores the information in the transmitting and light-shielding storage unit 54.

According to the configuration, only the panel 21 under the foot of the visitor on the floor 91 of the observation room 81a is controlled to the light-shielding state or the transmitting state, and the other panels 21 are controlled to the transmitting state or the light-shielding state. According to the direction, when the visitor walks on the floor 91 of the observation room 81a, the visitor can enjoy the direction in which only the panel 21 of the floor 91 which the visitor newly enters is controlled to the light-shielding state or the transmitting state in accordance with movement of the foot.

### Floor Partial Transmission Processing by Light-Shielding Device Illustrated in FIG. 11

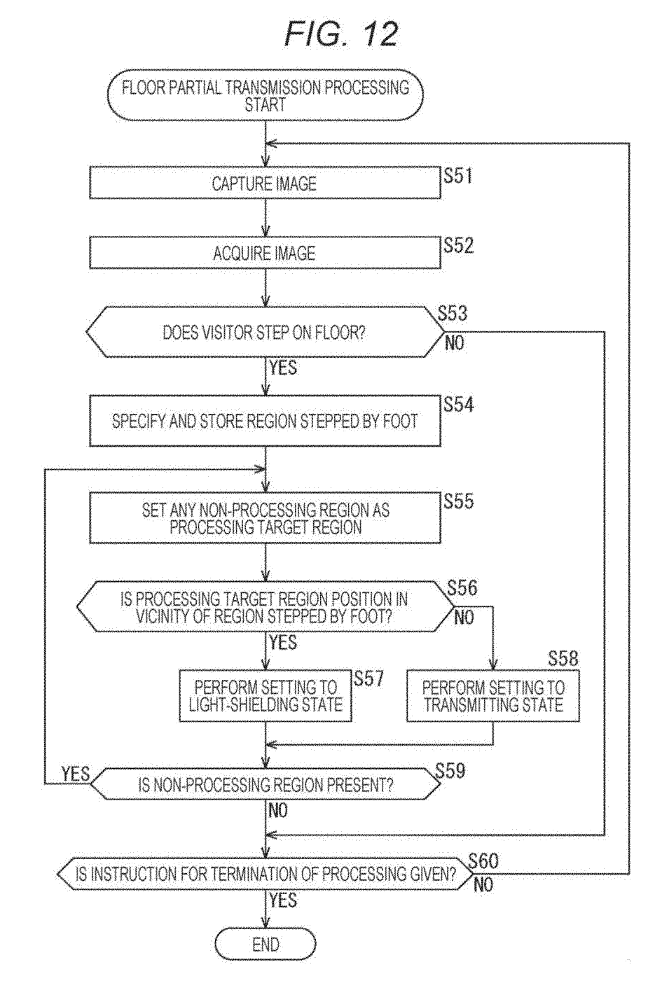

Next, floor partial transmission processing in the control unit 13 of the light-shielding device illustrated in FIG. 11 will be described with reference to a flowchart in FIG. 12.

In step S51, the camera 12 captures an image of the observation room 81a on the floor 91 constituted by the light-shielding wall 11 as a depth image, and supplies the depth image to the image acquisition unit 51.

In step S52, the image acquisition unit 51 supplies the depth image supplied from the camera 12 to the acquired image determination unit 111.

In step S53, the acquired image determination unit 11 detects a stepping foot of the visitor on the floor 91 from the depth image, determines whether or not the visitor newly enter a position on the floor 91 constituted by the light-shielding wall 11 in the observation room 81a, and supplies the determination result to the light-shielding and transmitting position calculation unit 112.

More specifically, the acquired image determination unit 111 performs foot image detection processing with respect to the depth image to detect a foot. In addition, the acquired image determination unit 111 determines whether or not the foot exists on the floor 91 constituted by the light-shielding wall 11 and the visitor steps into a new position on the basis of distance information in the depth image from the detected foot image.

In step S53, for example, in a case where it is determined that the foot of the visitor exists on the floor 91 constituted by the light-shielding wall 11, and the visitor steps into a new position on the floor 91, the processing proceeds to step S54, and position information of the foot of the visitor is supplied to the light-shielding and transmitting position calculation unit 112 in combination with the determination result.

In step S54, the light-shielding and transmitting position calculation unit 112 stores position information of the foot of the visitor on the floor 91 in the observation room 81a.

In step S55, the light-shielding and transmitting position calculation unit 112 sets any non-processing region in predetermined regions which are set in a unit of each panel 21 in the light-shielding wall 11 that constitutes the floor 91 as a processing handling region.

In step S56, the light-shielding and transmitting position calculation unit 112 determines whether or not a position of a panel 21 in a processing target region is a position of the foot of the visitor in the vicinity of the region on the floor 91 in the observation room 81a. In step S56, in a case where it is determined that the position of the panel 21 in the processing target region is the position of the foot of the visitor in the vicinity of the region on the floor 91 in the observation room 81a, the processing proceeds to step S57.

In step S57, the light-shielding and transmitting position calculation unit 112 stores light-shielding and transmitting information for controlling the panel 21 in the processing target region to the light-shielding state in the light-shielding and transmitting storage unit 54. According to the processing, the light-shielding and transmitting control unit 55 controls the panel 21 in the processing target region to the light-shielding state on the basis of the light-shielding and transmitting information stored in the light-shielding and transmitting storage unit 54.

On the other hand, in step S56, in a case where it is determined that the position of the panel 21 in the processing target region is not the position of the foot of the visitor in the vicinity of the region on the floor 91 in the observation room 81a, the processing proceeds to step S58.

In step S58, the light-shielding and transmitting position calculation unit 112 stores light-shielding and transmitting information for controlling the panel 21 in the processing target region to the transmitting state in the light-shielding and transmitting storage unit 54. According to the processing, the light-shielding and transmitting control unit 55 controls the panel 21 in the processing target region to the transmitting state on the basis of the light-shielding and transmitting information stored in the light-shielding and transmitting storage unit 54.

In step S59, the light-shielding and transmitting position calculation unit 112 determines whether or not a non-processing region exists among regions set in a unit of the panel 21 in the light-shielding wall 11, and in a case where it is determined that the non-processing region exists, the processing returns to step S55. That is, the processing from step S55 to step S59 is repeated until the non-processing region disappears. Then, in step S59, in a case where it is determined that the non-processing region does not exist, the processing proceeds to step S60. Furthermore, in step S53, in a case where it is determined that the foot of the visitor does not step into a new position on the floor 91 constituted by the light-shielding wall 11, the processing from step S54 to step S59 is skipped.

In step S60, the acquired image determination unit 111 determines whether or not an instruction for termination of the processing is given, and in a case where it is determined that the instruction for termination is not given, the processing returns to step S51, and the subsequent processing is repeated. Then, in step S60, in a case where it is determined that the instruction for termination is given, the processing is terminated.

That is, according to the above-described processing, as illustrated at the right portion in FIG. 10, when the visitor steps into a new position on the floor 91 constituted by the light-shielding wall 11, a panel 21 at a position stepped by the foot is controlled to the light-shielding state, and the other panels 21 are controlled to the transmitting state. In the other states, the entirety of the panels 21 are controlled to the transmitting state.

Accordingly, the entirety of the panels 21 are controlled to the transmitting state until the visitor steps into a new position on the floor 91. Accordingly, when stepping into a new position on the floor 91 constituted by the light-shielding wall 11, only a panel 21 stepped by the foot of the visitor enters the light-shielding state. Accordingly, it is possible to realize direction in which footing is possible when stepping into a new position. Further, it is possible to realize direction in which panels 21, which enter the light-shielding state that becomes the footing, are sequentially shown under the stepping foot in accordance with movement of the stepping foot while walking on the floor 91.

Furthermore, description has been given of an example in which a panel 21 at a position which the visitor newly enters is controlled to the light-shielding state, and the other panels 21 are controlled to the transmitting state, but control of the light-shielding state and control of the transmitting state may be reversed. In this case, the entire surface of the floor 91 is controlled to the light-shielding state before the visitor steps into a new position, and at a moment when the visitor steps into a new position, a panel 21 of the floor 91 under the foot is controlled to the transmitting state, and thus it is possible to realize direction in which the floor 91 of a stepped position falls out.

In addition, description has been given of an example in which the position of the foot of the visitor is specified by using the depth image captured by the camera 12, but the position of the foot may be specified by using a two-dimensional image or sensor data that is obtained by other sensors.

Further, the position of the foot on the floor 91 constituted by the light-shielding wall 11 may be detected by configurations other than the depth image captured by the camera 12 or a typical two-dimensional image. For example, the position of the foot may be detected by using an infrared sensor, a touch sensor, and the like.

In addition, description has been given of an example in which the floor 91 under the foot is controlled to the transmitting state or the light-shielding state when the visitor steps into a new position on the floor 91 of the observation room 81a. However, a ceiling may be constituted by the light-shielding wall 11, and when the visitor steps into a new position of the observation room 81a and the like, a panel 21 which constitutes the ceiling immediately above the visitor may be controlled to the transmitting state or the light-shielding state, and the other panels 21 may be controlled to the light-shielding state or the transmitting state.

### 5. Fourth Embodiment

Description has been given of an example in which the light-shielding wall 11 is applied as the floor 91 of the observation room 81a of the tower 81 for touring, and when the visitor steps into a new position on the floor 91 constituted by the light-shielding wall 11, a panel 21 in a region corresponding to a position under the foot of the visitor on the floor 91 is controlled to the light-shielding state or the transmitting state, and panels 21 in regions other than the region are controlled to the transmitting state or the light-shielding state. However, the light-shielding wall 11 may be used as a window, and may be controlled to the transmitting state or the light-shielding state in correspondence with presence or absence of approaching of a suspicious person as a peripheral state of the window, and locking and unlocking of a lock of the window may be controlled in correspondence with presence or absence of approaching.

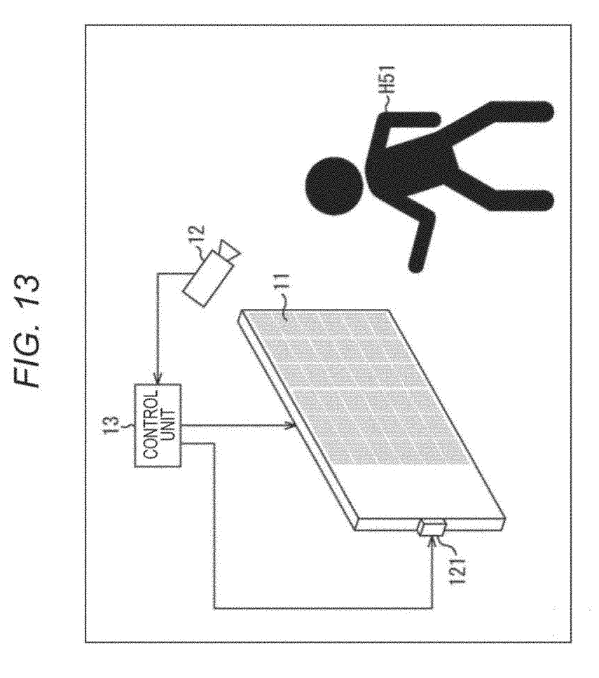

FIG. 13 illustrates an example of a light-shielding device in which the light-shielding wall 11 is used as a window, presence or absence of approaching of a suspicious person is detected as a peripheral state of the window, the transmitting state or the light-shielding state of the panels 21 of the light-shielding wall 11 that constitutes the window is controlled, and locking and unlocking of a lock of the window is controlled.

That is, in the light-shielding device illustrated in FIG. 13, when an outdoor image, which is captured by the camera 12, on an outer side of a window constituted by the light-shielding wall 11 is supplied to the control unit 13, the control unit 13 detects presence or absence of a suspicious person H51 from the image, and when the suspicious person H51 is detected, the control unit 13 controls a panel 21 in a region corresponding to a visual field range of the suspicious person H51 in the light-shielding wall 11 that constitutes the window to the light-shielding state, and controls a smart lock 121 that is a lock of the window to control the lock to a locked state. In addition, in a case where a suspicious person is not detected, the control unit 13 controls the entirety of the panels 21 of the light-shielding wall 11 that constitutes the window to the transmitting state, and controls the smart lock 121 that is a lock of the window to an unlocked state.

According to the configuration, invasion of the suspicious person is suppressed, and even in a case where a user who is a resident exists on an indoor side that is an inner side of the window constituted by the light-shielding wall 11, a situation such as collision with the suspicious person is suppressed, and thus it is possible to suppress crimes such as injury to the resident by the suspicious person. In addition, in a state in which the suspicious person does not exist, the smart lock 121 enters an unlocked state, and thus the user who is a resident can prevent invasion of the suspicious person while easily performing opening/closing of the window without considering locking/unlocking of the lock.

### Configuration Example for Realizing Light-Shielding Device Illustrated in FIG. 13

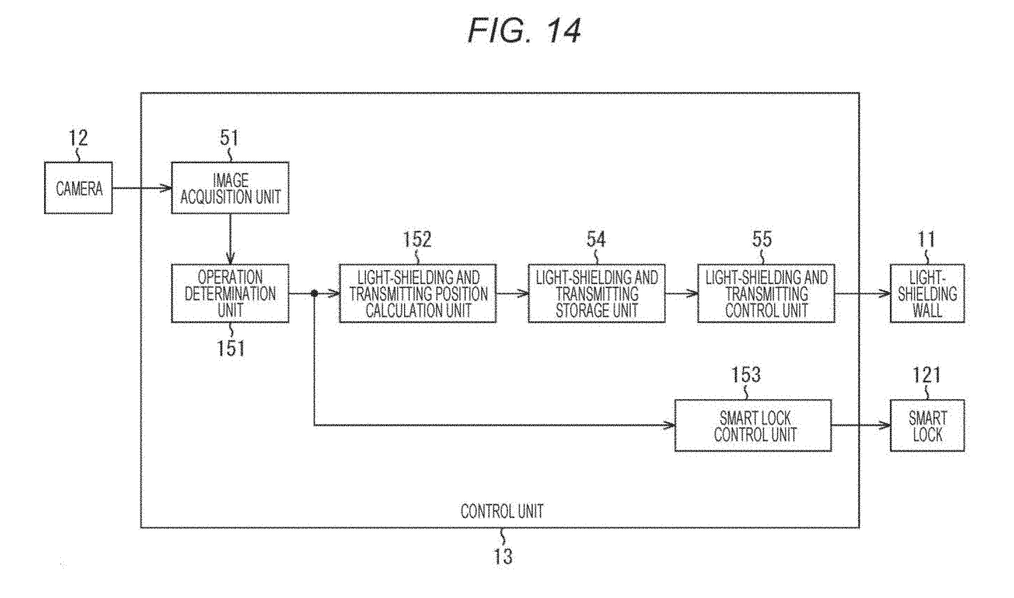

Next, a detailed configuration for realizing the light-shielding device illustrated in FIG. 13 will be described with reference to a block diagram in FIG. 14. Furthermore, the light-shielding wall 11 and the camera 12 which constitute the window have the same function as described with reference to FIG. 1 to FIG. 3, and thus description thereof will be appropriately omitted. In addition, in the configuration illustrated in FIG. 14, the same reference numeral and the same terminology will be given to a configuration having the same function as that of the configuration in FIG. 5, and description thereof will be appropriately omitted.

Specifically, the light-shielding device illustrated in FIG. 14 is different from the light-shielding device illustrated in FIG. 5 in that an operation determination unit 151 and a light-shielding and transmitting position calculation unit 152 are provided instead of the acquired image determination unit 52 and the light-shielding and transmitting position calculation unit 53, and a smart lock control unit 153 that controls locking and unlocking of the smart lock 121 is further provided.

In addition, the operation determination unit 151 determines whether or not the suspicious person is present on the basis of the depth image supplied from the image acquisition unit 51, and in a case where it is determined that the suspicious person is present, the operation determination unit 151 supplies information of a region of the window constituted by the light-shielding wall 11, which becomes a visual field range of the suspicious person, to the light-shielding and transmitting position calculation unit 152, and supplies information indicating presence or absence of the suspicious person to the smart lock control unit 153.

When acquiring the information of the region of the window constituted by the light-shielding wall 11, which becomes the visual field range of the suspicious person, in combination with the determination result indicating that the suspicious person is detected, the light-shielding and transmitting position calculation unit 152 specifies a position of a corresponding panel 21, controls the panel 21 to the light-shielding state, and sets the entirety of the panels 21 of the light-shielding wall 11 to the transmitting state in a case where the suspicious person is not detected.

The smart lock control unit 153 controls the smart lock 121 that is a lock of the window to be locked in a case where the suspicious person is detected, and controls the smart lock 121 to be unlocked in a case where the suspicious person is not detected.

According to the configuration, in a case where approaching of the suspicious person is detected in the light-shielding wall 11 as the window, a panel 21 in a region that becomes a visual field range of the suspicious person is controlled to the light-shielding state, the other panels 21 are controlled to the transmitting state, and the smart lock 121 is locked. In addition, in a case where approaching of the suspicious person is not detected, the entirety of the panels 21 are controlled to the transmitting state, and the smart lock 121 is unlocked.

### Security Processing by Light-Shielding Device Illustrated in FIG. 14

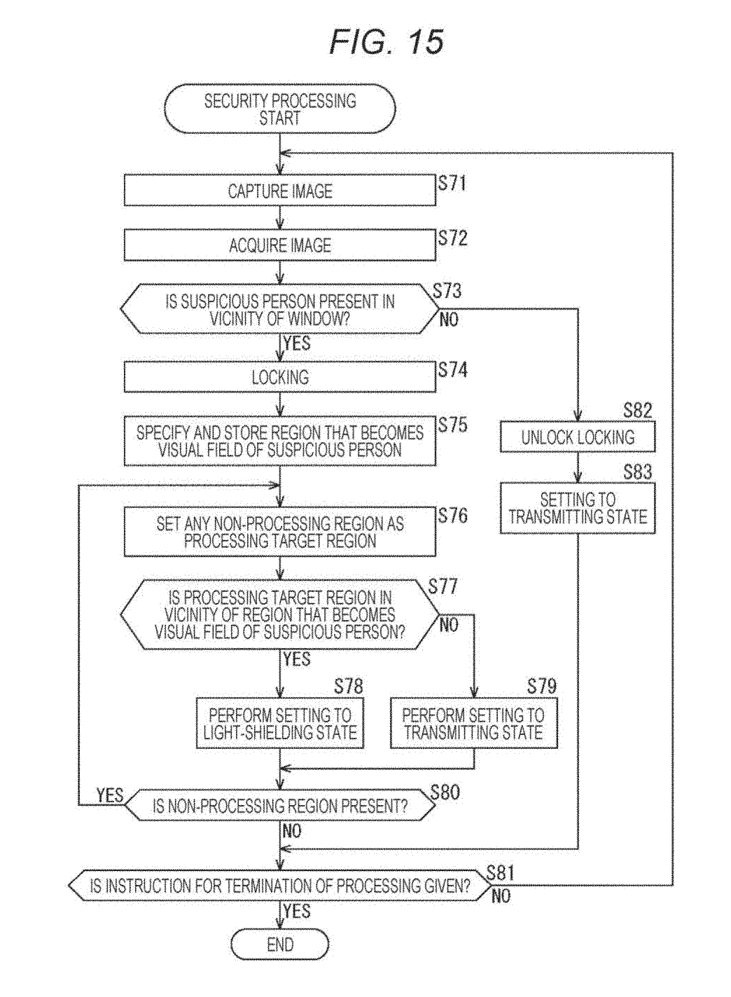

Next, security processing in the control unit 13 of the light-shielding device illustrated in FIG. 14 will be described with reference to a flowchart in FIG. 15.

In step S71, the camera 12 captures an image of the exterior that is an outer side of the vicinity of the window constituted by the light-shielding wall 11 as a depth image, and supplies the depth image to the image acquisition unit 51.

In step S72, the image acquisition unit 51 supplies the depth image supplied from the camera 12 to the operation determination unit 151.

In step S73, the operation determination unit 151 analyzes the depth image to detect a suspicious person, and determines whether or not the suspicious person is present in the vicinity of the window constituted by the light-shielding wall 11.

More specifically, the operation determination unit 151 registers a face image of a user who is an indoor resident on an inner side of the window constituted by the light-shielding wall 11 in a storage unit (not illustrated) in advance, detects a face image from the depth image, and compares the face image with the registered face image of the resident to determine whether or not the suspicious person is present in accordance with matching or non-matching between the face images. In addition, in a case where a moving image is captured by the camera 12, the operation determination unit 151 may detect a person from the moving image, and may continuously analyze movement of the detected person to detect the suspicious person. That is, the operation determination unit 151 may compare an action of a person of which an image is captured as the moving image, and an action that is registered in the storage unit (not illustrated) in advance as a suspicious action, and may determine whether or not the person is the suspicious person on the basis of whether or not actions match each other.

For example, the operation determination unit 151 repeats processing of detecting a face image from the image captured by the camera 12, and in a case where the face image is detected, the operation determination unit 151 compares the face image with the face image, which is registered in advance, of the user who is the resident to determine whether or not the suspicious person is present in accordance with matching or non-matching between the faces. Furthermore, in a case where the face image is not detected, the operation determination unit 151 determines that the suspicious person is not present.

In step S73, in a case where it is determined that the suspicious person is present, the processing proceeds to step S74.

In step S74, the operation determination unit 151 supplies a determination result indicating that the suspicious person is present to the smart lock control unit 153. The smart lock control unit 153 controls the smart lock 121 to a locked state on the basis of the determination result.

In step S75, the operation determination unit 151 specifies a position with respect to the window constituted by the light-shielding wall 11 from a position of the face image of the suspicious person, who is present in the detected image, in the depth image, obtains a visual field range of the suspicious person, and stores the visual field range in the light-shielding and transmitting position calculation unit 152.

In step S76, the light-shielding and transmitting position calculation unit 152 sets any non-processing region among predetermined regions which are set in a unit of each panel 21 in the light-shielding wall 11 that constitutes the window as a processing handling region.

In step S77, the light-shielding and transmitting position calculation unit 152 determines whether or not the position of the panel 21 in the processing target region is a position in the vicinity of a region in the visual field range of the suspicious person. In step S77, in a case where it is determined that the position of the panel 21 in the processing target region is a position in the vicinity of a region in the visual field range of the suspicious person, the processing proceeds to step S78.

In step S78, the light-shielding and transmitting position calculation unit 152 stores light-shielding and transmitting information for controlling the panel 21 in the processing target region to the light-shielding state in the light-shielding and transmitting storage unit 54. According to the processing, the light-shielding and transmitting control unit 55 controls the panel 21 in the processing target region to the light-shielding state on the basis of the light-shielding and transmitting information stored in the light-shielding and transmitting storage unit 54.

On the other hand, in step S77, in a case where it is determined that the position of the panel 21 in the processing target region is not the position in the vicinity of the region in the visual field range of the suspicious person, the processing proceeds to step S79.

In step S79, the light-shielding and transmitting position calculation unit 152 stores light-shielding and transmitting information for controlling the panel 21 in the processing target region to the transmitting state in the light-shielding and transmitting storage unit 54. According to the processing, the light-shielding and transmitting control unit 55 controls the panel 21 in the processing target region to the transmitting state on the basis of the light-shielding and transmitting information stored in the light-shielding and transmitting storage unit 54.

In step S80, the light-shielding and transmitting position calculation unit 152 determines whether or not a non-processing region exists among regions set in a unit of each panel 21 in the light-shielding wall 11, and in a case where it is determined that the non-processing region exists, the processing returns to step S76. That is, the processing from step S76 to step S80 is repeated until the non-processing region disappears. Then, in step S80, in a case where it is determined that the non-processing region does not exist, the processing proceeds to step S81.

In step S81, the acquired image determination unit 111 determines whether or not an instruction for termination of the processing is given, and in a case where it is determined that the instruction for termination of the processing is not given, the processing returns to step S71, and the subsequent processing is repeated. Then, in step S81, in a case where it is determined that the instruction for termination of the processing is given, the processing is terminated.

In addition, in step S73, in a case where it is determined that the suspicious person is not present in the vicinity of the window constituted by the light-shielding wall 11, the processing proceeds to step S82.

In step S82, the operation determination unit 151 supplies a determination result indicating that the suspicious person is not present to the smart lock control unit 153. The smart lock control unit 153 controls the smart lock 121 to a state (unlocked state) in which locking is released on the basis of the determination result.

In step S83, the operation determination unit 151 instructs the light-shielding and transmitting position calculation unit 152 to control the entirety of the panels 21 in the light-shielding wall 11 to the transmitting state. According to this, the light-shielding and transmitting position calculation unit 152 generates light-shielding and transmitting information for controlling the entirety of the panels 21 to the transmitting state, and stores the information in the light-shielding and transmitting storage unit 54. According to the processing, the light-shielding and transmitting control unit 55 controls the entirety of the panels 21 to the transmitting state.

That is, according to the above-described processing, as illustrated in FIG. 13, the suspicious person is detected in the vicinity of the window constituted by the light-shielding wall 11, the panel 21 corresponding to a region on the light-shielding wall 11, which becomes a visual field range of the suspicious person, is controlled to the light-shielding state, the other panels 21 are controlled to the transmitting state, and the smart lock 121 is set to a locked state. In addition, in a case where the suspicious person is not detected, the entirety of the panels 21 are controlled to the transmitting state, and the smart lock 121 is unlocked.

Accordingly, only when the suspicious person approaches the window, the window is locked by the smart lock 121, and the window is unlocked in other states. Accordingly, a user who is an indoor resident on an inner side of the window constituted by the light-shielding wall 11 can open/close the window constituted by the light-shielding wall 11 without considering locking or unlocking of a lock.

In addition, in a case where the suspicious person approaches the window, even when the resident exists indoors, a situation such as collision with the suspicious person is suppressed, and thus it is possible to suppress crimes such as injury to a user who is the resident by the suspicious person.

### 6. Fifth Embodiment

Description has been given of an example in which the light-shielding wall 11 is used as a window and is controlled to the transmitting state or the light-shielding state in correspondence with presence or absence of approaching of a suspicious person as a peripheral state of the window, and locking and unlocking of a lock of the window is controlled in correspondence with presence or absence of approaching. However, there is no limitation thereto, and for example, a road wall constituted by the light-shielding wall 11 may be provided at a boundary between a road and a resident area at a roadside, a range in which the resident area is visible to an occupant of a vehicle may be controlled to the light-shielding state in correspondence with the position of the vehicle, and the other ranges may be controlled to the transmitting state.

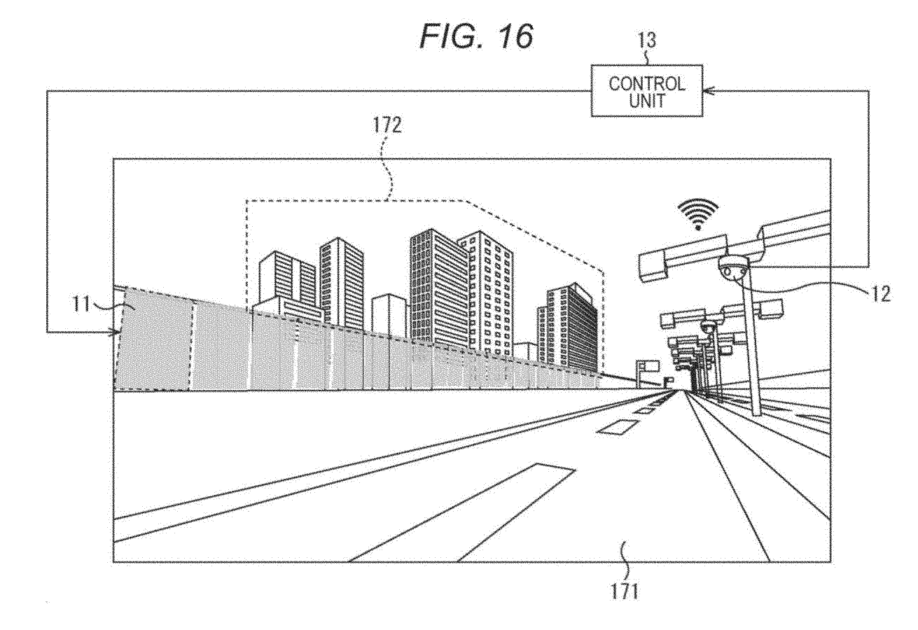

FIG. 16 illustrates an example of a light-shielding device in which a road wall constituted by the light-shielding wall 11 is provided at a boundary between a road and a resident area at a roadside, a panel 21 of the road wall in a range in which the resident area is visible to an occupant to a vehicle is controlled to the light-shielding state in correspondence with the position of the vehicle that travels on the road, and panels 21 in the other ranges are controlled to the transmitting state.

That is, in the light-shielding device illustrated in FIG. 16, an image of a vehicle that is travelling on a road 171 is captured by a camera 12 provided over the road 171 and is supplied to the control unit 13, and the control unit 13 controls a panel 21 of the light-shielding wall 11 which corresponds to a range in which the resident area 172 is visible to an occupant of a vehicle from a position of the vehicle that is specified from the image to the light-shielding state, and the other panels are controlled to the transmitting state.

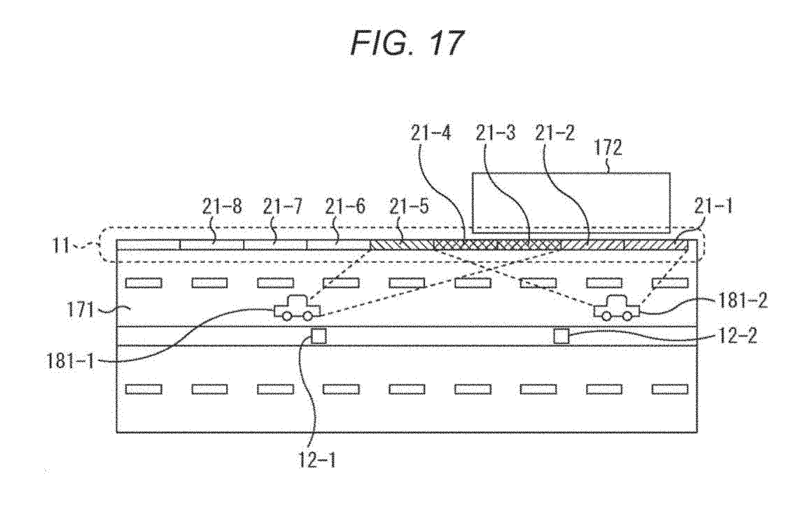

More specifically, for example, as illustrated in FIG. 17, a road wall constituted by the light-shielding wall 11 is provided at a boundary between the road 171 and the resident area 172, the light-shielding wall 11 is provided, for example, along the road 171, and panels 21-1 to 21-8 which constitute the light-shielding wall 11 are individually controlled to the light-shielding state or the transmitting state, respectively. In addition, as indicated by cameras 12-1 and 12-2, the cameras 12-1 and 12-2 are provided at a central separation zone of the road 171, captures an image of a vehicle 181 that travels, and supplies the image to the control unit 13.

Here, for example, it is assumed that the vehicle 181 is travelling from a left side toward a right side in the drawing. At this time, the camera 12-1 captures an image of a vehicle 181-1 on the right side in the drawing among a plurality of the vehicles 181 as a depth image, and supplies the depth image to the control unit 13. The control unit 13 obtains a positional relationship between the vehicle 181-1 and the resident area 172 from the depth image, controls a panel 21 in a range, in which the resident area 172 is visible to an occupant of the vehicle 181-1 through the panel 21 when being controlled to the transmitting state, among panels 21 which constitute the light-shielding wall 11 is controlled to the light-shielding state, and the other panels 21 are controlled to the transmitting state. In FIG. 17, only the panels 21-3 to 21-5 are controlled to the light-shielding state, and the other panels 21 are controlled to the transmitting state.

Further, in a case where the vehicle 181-1 moves to a position of a vehicle 181-2 on the right side in the drawing with the elapse of time, the control unit 13 controls only the panels 21-1 to 21-4 of the light-shielding wall 11 to the light-shielding state, and controls the other panels 21 to the transmitting state.

That is, in the road wall constituted by the light-shielding wall 11, only a panel 21 in a range in which the vehicle 181 travelling on the road 171 approaches the resident area 172 and the resident area 172 is visible to the occupant of the vehicle 181 is set to the light-shielding state, and panels 21 in the other ranges are set to the transmitting state.

As a result, at timing at which the vehicle 181 travels on the road 171 and approaches the resident area 172, only a panel 21 in a range visible to the occupant is controlled to the light-shielding state, and thus it is possible to protect privacy of residents in the resident area 172. In addition, the panels 21 of the light-shielding wall 11 that constitutes the road wall are maintained to the transmitting state as long as the vehicle 181 does not travel, and thus it is possible to realize a road wall that is less in a sense of oppression in comparison to a case where a road wall fixed to the light-shielding state is provided.

### Configuration Example for Realizing Light-Shielding Device Illustrated in FIG. 16 and FIG. 17

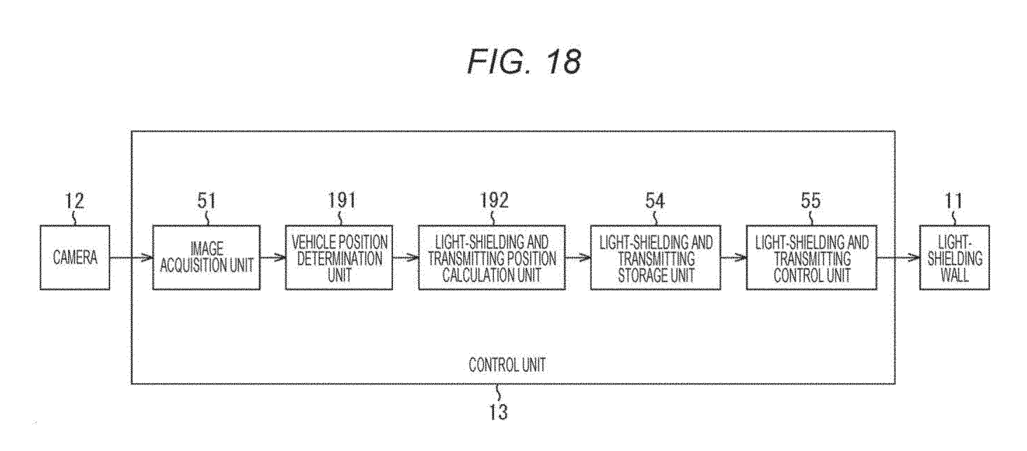

Next, a detailed configuration for realizing the light-shielding device illustrated in FIG. 16 and FIG. 17 will be described with reference to a block diagram in FIG. 18. Furthermore, the light-shielding wall 11 and the camera 12 which constitute the road wall have the same function as described with reference to FIG. 1 to FIG. 3, and thus description thereof will be appropriately omitted. In addition, in the configuration illustrated in FIG. 18, the same reference numeral and the same terminology will be given to a configuration having the same function as that of the configuration in FIG. 5, and description thereof will be appropriately omitted.

Specifically, the light-shielding device illustrated in FIG. 18 is different from the light-shielding device illustrated in FIG. 5 in that a vehicle position determination unit 191 and a light-shielding and transmitting position calculation unit 192 are provided instead of the acquired image determination unit 52 and the light-shielding and transmitting position calculation unit 53.

The vehicle position determination unit 191 specifies a position of the vehicle 181 on the road 171 on the basis of the depth image that is captured by the camera 12 provided along the central separation zone of the road 171 and is supplied from the image acquisition unit 51, determines whether or not the vehicle 181 in which the resident area 172 is visible to the occupant is present on the basis of position information of the specified vehicle 181, and supplies the determination result to the light-shielding and transmitting position calculation unit 192. At this time, in a case where it is determined that the vehicle 181 in which the resident area 172 is visible to the occupant is present, the vehicle position determination unit 191 also supplies the position information of the vehicle 181 to the light-shielding and transmitting position calculation unit 192.

When acquiring the position information of the detected vehicle 181 in combination with the determination result indicating that a vehicle is detected, the light-shielding and transmitting position calculation unit 192 generates light-shielding and transmitting information for controlling a panel 21 of the light-shielding wall 11 which exists in a range in which the resident area 172 is visible to the occupant of the vehicle 181 to the light-shielding state and controlling the other panels 21 to the transmitting state, and stores the information in the light-shielding and transmitting storage unit 54. That is, the road wall constituted by the light-shielding wall 11 is typically controlled to the transmitting state, and in this state, the inside of a house and the like in the resident area 172 are visually recognized to the occupant of the vehicle 181 that travels on the road 171 through the road wall constituted by the light-shielding wall 11 in the transmitting state. Here, in a case where the vehicle 181 occupied by the occupant capable of visually recognizing the resident area 172 is detected, when the vehicle 181 passes, a panel 21 of the light-shielding wall 11 in a region in which the resident area 172 is visually recognized to the occupant is controlled to the light-shielding state, and the other panels 21 are controlled to the transmitting state.

According to the configuration, in the light-shielding wall 11 as the road wall, a panel 21 in a range in which the resident area is visible to an occupant among a plurality of the vehicles 181 which travel on the road is controlled to the light-shielding state, and thus it is possible to protect privacy of residents in the resident area 172. In addition, in a case where the vehicle 181 in which the resident area 172 is visible to the occupant is not present on the road 171, the entirety of the panels 21 of the light-shielding wall 11 as the road wall are controlled to the transmitting state, and thus it is possible to realize a road wall that does not give unnecessary sense of oppression, in which a landscape on the road 171 side is invisible, to residents in the resident area 172.

### Road Wall Blind Processing by Light-Shielding Device Illustrated in FIG. 18

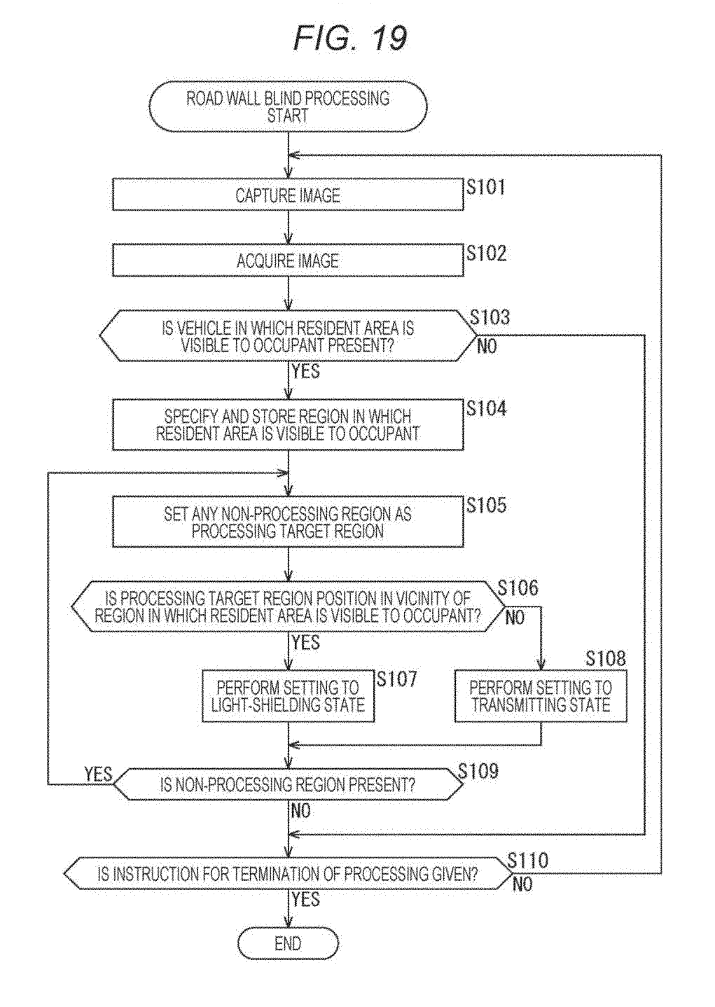

Next, road wall blind processing in the control unit 13 of the light-shielding device illustrated in FIG. 18 will be described with reference to a flowchart in FIG. 19.

In step S101, the camera 12 provided along the road 171 captures an image on the road 171 as a depth image, and supplies the depth image to the image acquisition unit 51.

In step S102, the image acquisition unit 51 supplies the depth image supplied from the camera 12 to the vehicle position determination unit 191.

In step S103, the vehicle position determination unit 191 determines whether or not the vehicle 181, which travels on the road 171 and in which the resident area 172 is visible to an occupant, is present from the depth image.

More specifically, the vehicle position determination unit 191 detects the vehicle 181 from the depth image captured by the camera 12, and in a case where it is determined that the vehicle 181 is detected, the vehicle position determination unit 191 further specifies the occupant of the detected vehicle 181, estimates a visual line of the specified occupant, and determines whether or not the vehicle 181 occupied by the occupant to which the resident area 172 is visible is present. Furthermore, in a case where it is determined that the vehicle 181 is not detected, the vehicle position determination unit 191 determines that the vehicle 181 occupied by the occupant to which the resident area 172 is visible is not present.

In step S103, in a case where it is determined that the vehicle 181 in which the resident area 172 is visible to the occupant is present, the processing proceeds to step S104.

In step S104, the vehicle position determination unit 191 obtains a position with respect to the road wall constituted by the light-shielding wall 11 from a position in the depth image of the vehicle 181 in which the resident area 172 is visible to the occupant to obtain a region in which the resident area 172 is visible to the occupant, and stores the region in the light-shielding and transmitting position calculation unit 192.

In step S105, the light-shielding and transmitting position calculation unit 192 sets any non-processing region in predetermined regions which are set in a unit of each panel 21 in the light-shielding wall 11 that constitutes the road wall as a processing handling region.

In step S106, the light-shielding and transmitting position calculation unit 192 determines a position of the panel 21 in the processing target region is a position in the vicinity of the region of the resident area 172 visible to the occupant. In step S105, in a case where it is determined that the position of the panel 21 in the processing target region is the position in the vicinity of the region in which the resident area 172 is visible to the occupant of the vehicle that travels on the road 171, the processing proceeds to step S107.

In step S107, the light-shielding and transmitting position calculation unit 192 stores light-shielding and transmitting information for controlling the panel 21 in the processing target region to the light-shielding state in the light-shielding and transmitting storage unit 54. According to the processing, the light-shielding and transmitting control unit 55 controls the panel 21 in the processing target region to the light-shielding state on the basis of the light-shielding and transmitting information stored in the light-shielding and transmitting storage unit 54.

On the other hand, in step S106, in a case where it is determined that the position of the panel 21 in the processing target region is not the position in the vicinity of the region in which the resident area 172 is visible to the occupant of the vehicle that travels on the road 171, the processing proceeds to step S108.

In step S108, the light-shielding and transmitting position calculation unit 192 stores light-shielding and transmitting information for controlling the panel 21 in the processing target region to the transmitting state in the light-shielding and transmitting storage unit 54. According to the processing, the light-shielding and transmitting control unit 55 controls the panel 21 in the processing target region to the transmitting state on the basis of the light-shielding and transmitting information stored in the light-shielding and transmitting storage unit 54.

In step S109, the light-shielding and transmitting position calculation unit 192 determines whether or not a non-processing region exists among regions set in a unit of the panel 21 in the light-shielding wall 11, and in a case where it is determined that the non-processing region exists, the processing returns to step S105. That is, the processing from step S105 to step S109 is repeated until the non-processing region disappears. Then, in step S109, in a case where it is determined that the non-processing region does not exist, the processing proceeds to step S110. Furthermore, in step S103, in a case where it is determined that the vehicle 181 in which the resident area 172 is visible to the occupant is not present, the processing from step S104 to step S109 is skipped.

In step S110, the vehicle position determination unit 191 determines whether or not an instruction for termination of the processing is given, and in a case where it is determined that the instruction for termination is not given, the processing returns to step S101, and the subsequent processing is repeated. Then, in step S110, in a case where it is determined that the instruction for termination is given, the processing is terminated.

Specifically, according to the above-described processing, as illustrated in FIG. 16 and FIG. 17, when the vehicle 181, that travels on the road 171 and that is the vehicle 108 in which the resident area 172 opposite to the road 171 with the road wall constituted by the light-shielding wall 11 interposed therebetween is visible to the occupant, is detected, a panel 21 in a region in which the resident area 172 is visible to the occupant of the vehicle 181 in the light-shielding wall 11 is controlled to the light-shielding state, and the other panels 21 are controlled to the transmitting state.

As a result, according to the above-described processing, in the light-shielding wall 11 as the road wall, a panel 21 in a region in which a resident area is visible to an occupant of the vehicle 181 which travels on a load is controlled to the light-shielding state, and thus it is possible to protect privacy of residences of the resident area 172. In addition, in a case where the vehicle 181 in which the resident area 172 is visible to the occupant do not exist on the road 171, the entirety of the panels 21 of the light-shielding wall 11 as the road wall are controlled to the transmitting state, and thus it is possible to realize a road wall that does not give unnecessary sense of oppression to residents in the resident area 172. Further, in a range in which the resident area 172 is not present along the road 171, the entirety of the panels 21 of the light-shielding wall 11 as the road wall are set to the transmitting state, and thus the occupant of the vehicle 181 can obtain open travelling sense. In addition, in correspondence with a situation in which the vehicle 181 passes through the road 171, for example, in a case where the resident area 172 is present along the road 171, when the vehicle 181 travels at a speed lower than a speed limit, the occupant of the vehicle 181 is likely to visually recognize the resident area 172, and thus the panels 21 of the light-shielding wall 11 as the road wall may be controlled to the light-shielding state. In this case, priority can be given to protection of privacy. In contrast, even in a case where the resident area 172 is present along the road 171, when the vehicle 181 travels at a speed higher than the speed limit, the occupant of the vehicle 181 is less likely to visually recognize the resident area 172, and thus the panels 21 of the light-shielding wall 11 as the road wall may be controlled to the transmitting state. In this case, it is possible to realize a road wall that gives sense of openness both the residents in the resident area and the occupant of the vehicle 181.

### Example of Execution by Software

The above-described series of processing can be executed by hardware, but can be executed by the software. In a case where the series of processing is executed by software, a program that constitutes the software is installed from a recording medium in a computer provided with exclusive hardware, a general-purpose personal computer to which various programs are installed to execute various functions, and the like.

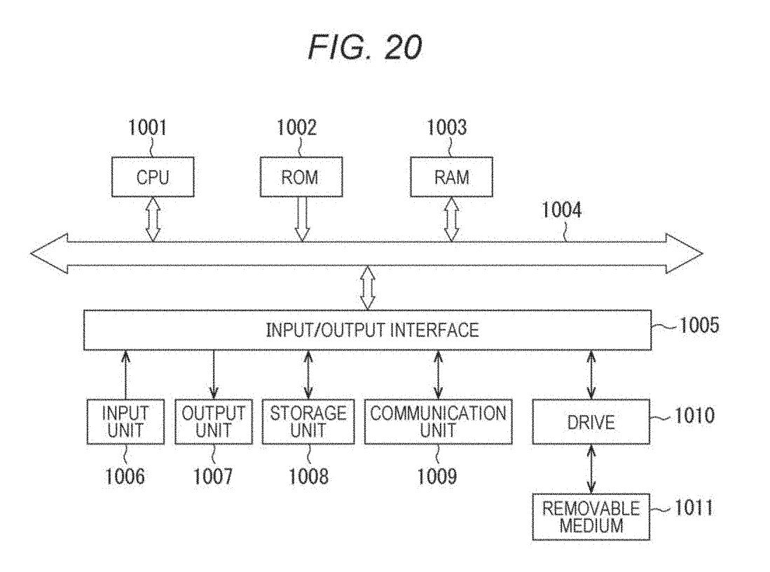

FIG. 20 illustrates a configuration example of the general-purpose personal computer. The personal computer is provided with a central processing unit (CPU) 1001. An input/output interface 1005 is connected to the CPU 1001 through a bus 1004. A read only memory (ROM) 1002 and a random access memory (RAM) 1003 are connected to the bus 1004.

An input unit 1006 including an input device such as a keyboard and a mouse which are used to input an operation command by a user, an output unit 1007 that outputs a processing operation screen or a processing result image to a display device, a storage unit 1008 such as a hard disc drive that stores a program or various pieces of data, and a communication unit 1009 that includes a local area network (LAN) adapter and the like, and executes communication processing through a network represented by the Internet are connected to the input/output interface 1005. In addition, a drive 1010 that performs reading/writing of data with respect to a removable medium 1011 such as a magnetic disk (including a flexible disk), an optical disc (including a compact disc-read only memory (CD-ROM) and a digital versatile disc (DVD)), a magneto-optical disc (including a mini disc (MD)), and a semiconductor memory is connected to the input/output interface 1005.

The CPU 1001 executes various kinds of processing in accordance with programs which are stored in the ROM 1002, or programs which are read out from the removable medium 1011 such as the magnetic disk, the optical disc, the magneto-optical disc, and the semiconductor memory, are installed in the storage unit 1008, and are loaded from the storage unit 1008 into the RAM 1003. Data necessary for execution of the various kinds of processing by the CPU 1001, or the like is also appropriately stored in the RAM 1003.

In the computer having the above-described configuration, the CPU 1001 loads a program stored, for example, in the storage unit 1008 into the RAM 1003 through the input/output interface 1005 and the bus 1004 and executes the program, whereby the above-described series of processing is performed.

Furthermore, for example, the CPU 1001 in FIG. 20 is the control unit 13 in FIG. 5. The CPU 1001 accepts input of the depth image supplied from the camera 12 through the input unit 1006, executes the above-described series of processing, and outputs a signal for controlling the light-shielding wall 11 from the output unit 1007.

The program that is executed by the CPU 1001 can be provided in a state of being recorded, for example, on the removable medium 1011 as a package medium or the like. In addition the program can be provided through a wired or wireless transmission medium such as a local area network, the Internet, and digital satellite broadcasting.

In the computer, the programs can be installed in the storage unit 1008 through the input/output interface 1005 when the removable medium 1011 is mounted in the drive 1010. In addition, the programs can be installed in the storage unit 1008 after being received by the communication unit 1009 through the wired or wireless transmission medium. In addition, the programs can be installed in the ROM 1002 or the storage unit 1008 in advance.

Furthermore, the programs which are executed by the computer may be programs in which processing is performed in time series according to the procedure described in this specification, or may be programs in which processing is performed in parallel or at a necessary timing such as when a call is made.

In addition, in this specification, the system represents an assembly of a plurality of constituent elements (devices, modules (parts), and the like), and whether or not the entirety of the constituent elements exist in the same casing does not matter. Accordingly, all of a plurality of devices which are accommodated in individual casings and are connected through a network, and one device in which a plurality of modules are accommodated in one casing represent the system.

Furthermore, an embodiment of the present disclosure is not limited to the above-described embodiments, and various modifications can be made in a range not departing from the gist of the present disclosure.

For example, the present disclosure can have a cloud computing configuration in which one function is shared by a plurality of devices and is processed in cooperation through a network.

In addition, the respective steps described in the flowchart can be executed in a state of being shared by a plurality of devices in addition to execution by one device.

Further, in a case where a plurality of kinds of processing are included in one step, the plurality of kinds of processing included in one step can be executed in a state of being shared by a plurality of devices in addition to execution by one device.

Furthermore, the present disclosure can also employ the following configurations.

<1> A light-shielding device including:

a light-shielding wall that partitions a first space and a second space and includes a plurality of regions capable of being controlled to a transmitting state in which light is transmitted or a light-shielding state in which light is shielded;

a light-shielding and transmitting information generation unit that generates light-shielding and transmitting information for controlling the transmitting state or the light-shielding state of a position of each of the plurality of regions on the basis of information indicating a state of the vicinity of the light-shielding wall; and a control unit that controls the transmitting state or the light-shielding state of the plurality of regions of the light-shielding wall on the basis of the light-shielding and transmitting information generated by the light-shielding and transmitting information generation unit.

<2> The light-shielding device according to <1>,

in which the light-shielding wall is a window that separates the first space and the second space,

the information indicating the state of the vicinity of the light-shielding wall is information indicating whether or not user's eyes are present in the vicinity of the window constituted by the light-shielding wall, and

the light-shielding and transmitting information generation unit generates light-shielding and transmitting information for controlling the transmitting state or the light-shielding state of the position of each of the plurality of regions on the basis of information that indicates the state of the vicinity of the light-shielding wall and indicates whether or not the user's eyes are present in the vicinity of the window constituted by the light-shielding wall.

<3> The light-shielding device according to <2>,

in which on the basis of the information that indicates the state of the vicinity of the light-shielding wall and indicates whether or not the user's eyes are present in the vicinity of the window constituted by the light-shielding wall, the light-shielding and transmitting information generation unit generates light-shielding and transmitting information for controlling a region, which corresponds to a position of the user's eyes, in the light-shielding wall to the transmitting state, and controlling the other regions to the light-shielding state in a case where the position of the user's eyes is present in the vicinity of the window constituted by the light-shielding wall, and for controlling the entirety of the regions of the light-shielding wall to the light-shielding state in a case where the position of the user's eyes is not present in the vicinity of the window constituted by the light-shielding wall.

<4> The light-shielding device according to <3>,

in which the first space is a space in which an observation target exists, and the second space is an observation space for observation of the observation target,

the information indicating the state of the vicinity of the light-shielding wall further includes information indicating whether or not the light-shielding wall exists in a visual field of the observation target, and

the light-shielding and transmitting information generation unit generates light-shielding and transmitting information for controlling the transmitting state or the light-shielding state of the position of each of the plurality of regions on the basis of the information indicating whether or not the light-shielding wall exists in the visual field of the observation target, and the information indicating whether or not the user's eyes are present in the vicinity of the window constituted by the light-shielding wall.

<5> The light-shielding device according to <4>,

in which the light-shielding and transmitting information generation unit generates,

light-shielding and transmitting information for controlling the transmitting state or the light-shielding state of the position of each of the plurality of regions on the basis of the information indicating whether or not the user's eyes are present in the vicinity of the window constituted by the light-shielding wall in a case where the light-shielding wall exists in the visual field of the observation target, and

light-shielding and transmitting information for controlling the entirety of the plurality of regions to the transmitting state in a case where the light-shielding wall does not exist in the visual field of the observation target.

<6> The light-shielding device according to <5>,

in which the case where the light-shielding wall does not exist in the visual field of the observation target includes a case where the observation target is sufficiently spaced away from the light-shielding wall.

<7> The light-shielding device according to <1>, in which the light-shielding wall is a floor that separates the first space and the second space,

the information indicating the state of the vicinity of the light-shielding wall is information indicating whether or not a user steps into a new position on the floor, and

the light-shielding and transmitting information generation unit generates light-shielding and transmitting information for controlling the transmitting state or the light-shielding state of the position of each of the plurality of regions on the basis of the information that indicates the state in the vicinity of the light-shielding wall and indicates whether or not the user steps into the new position on the floor.

<8> The light-shielding device according to <7>,

in which the light-shielding and transmitting information generation unit generates light-shielding and transmitting information for controlling the region at a stepped position of a foot of a user to the transmitting state in a case where the user steps into a new position on the floor, and controlling the other regions to the light-shielding state.

<9> The light-shielding device according to <7>,

in which the light-shielding and transmitting information generation unit generates light-shielding and transmitting information for controlling the region at a stepped position of a foot of a user to the light-shielding state in a case where the user steps into a new position on the floor, and controlling the other regions to the transmitting state.

<10> The light-shielding device according to <1>,

in which the light-shielding wall is a window that separates the first space and the second space,

the light-shielding device further includes a lock control unit that control locking and unlocking of a lock of the window,

the information indicating the state in the vicinity of the light-shielding wall is information indicating whether or not a suspicious person is present,

the light-shielding and transmitting information generation unit generates light-shielding and transmitting information for controlling the transmitting state or the light-shielding state of the position of each of the plurality of regions on the basis of the information that indicates the state of the vicinity of the light-shielding wall and indicates whether or not the suspicious person is present, and

the lock control unit controls locking or unlocking of the lock of the window on the basis of the information indicating whether or not suspicious person is present.

<11> The light-shielding device according to <10>,

in which in a case where the suspicious person is present,

the light-shielding and transmitting information generation unit generates light-shielding and transmitting information for controlling a region in a visual field of the suspicious person to the light-shielding state and controlling the other regions to the transmitting state, and

the lock control unit controls the lock of the window to be locked, and

in a case where the suspicious person is not present,

the light-shielding and transmitting information generation unit generates light-shielding and transmitting information for controlling the entirety of the regions to the transmitting state, and

the lock control unit controls the lock of the window to be unlocked.

<12> The light-shielding device according to <1>,

in which the light-shielding wall is a road wall that separates a road and a resident area at a roadside,

the information indicating the state of the vicinity of the light-shielding wall is information indicating whether or not a vehicle, in which the resident area is visible to an occupant through the light-shielding wall in the transmitting state, travels on the road, and

the light-shielding and transmitting information generation unit generates the light-shielding and transmitting information for controlling the transmitting state or the light-shielding state of the position of each of the plurality of regions on the basis of the information that indicates the state in the vicinity of the light-shielding wall and indicates whether or not the vehicle, in which the resident area is visible to the occupant through the light-shielding wall in the transmitting state, travels on the road.

<13> The light-shielding device according to <12>,

in which on the basis of the information that indicates the state of the vicinity of the light-shielding wall and indicates whether or not the vehicle, in which the resident area is visible to the occupant through the light-shielding wall in the transmitting state, travels on the road, the light-shielding and transmitting information generation unit generates light-shielding and transmitting information for controlling a region in the light-shielding wall in which the resident area is visible to the occupant to the light-shielding state and controlling the other regions to the transmitting state in a case where the vehicle, in which the resident area is visible to the occupant through the light-shielding wall in the transmitting state, travels on the road, and for controlling the entirety of the regions of the light-shielding wall to the transmitting state in a case where the vehicle, in which the resident area is visible to the occupant through the light-shielding wall in the transmitting state, does not travel on the road.

<14> A light-shielding method of a light-shielding device including a light-shielding wall that partitions a first space and a second space and includes a plurality of regions capable of being controlled to a transmitting state in which light is transmitted or a light-shielding state in which light is shielded, the method including:

generating light-shielding and transmitting information for controlling the transmitting state or the light-shielding state of a position of each of the plurality of regions on the basis of information indicating a state of the vicinity of the light-shielding wall; and

controlling the transmitting state or the light-shielding state of the plurality of regions of the light-shielding wall on the basis of the light-shielding and transmitting information that is generated.

<15> A program that allows a computer to function as:

a light-shielding wall that partitions a first space and a second space and includes a plurality of regions capable of being controlled to a transmitting state in which light is transmitted or a light-shielding state in which light is shielded;

a light-shielding and transmitting information generation unit that generates light-shielding and transmitting information for controlling the transmitting state or the light-shielding state of a position of each of the plurality of regions on the basis of information indicating a state of the vicinity of the light-shielding wall; and

a control unit that controls the transmitting state or the light-shielding state of the plurality of regions of the light-shielding wall on the basis of the light-shielding and transmitting information generated by the light-shielding and transmitting information generation unit.

### REFERENCE SIGNS LIST

11 Light-shielding wall

12, 12-1, 12-2 Camera

13 Control unit

21, 21-A to 21-C, 21-1, 21-2, 21′ Panel

51, 51-1, 51-2 Image acquisition unit

52 Acquired image determination unit

53 Light-shielding and transmitting position calculation unit

54 Light-shielding and transmitting storage unit

55 Light-shielding and transmitting control unit

71 Acquired image determination unit

72 Light-shielding and transmitting position calculation unit

111 Acquired image determination unit

112 Light-shielding and transmitting position calculation unit

121 Smart lock

151 Operation determination unit

152 Light-shielding and transmitting position calculation unit

153 Smart lock control unit

171 Road

172 Resident area

181, 181-1, 181-2 Vehicle

191 Vehicle position determination unit

192 Light-shielding and transmitting position calculation unit

1. A light-shielding device comprising:
a light-shielding wall that partitions a first space and a second space and includes a plurality of regions capable of being controlled to a transmitting state in which light is transmitted or a light-shielding state in which light is shielded;
a light-shielding and transmitting information generation unit that generates light-shielding and transmitting information for controlling the transmitting state or the light-shielding state of a position of each of the plurality of regions on a basis of information indicating a state of a vicinity of the light-shielding wall; and
a control unit that controls the transmitting state or the light-shielding state of the plurality of regions of the light-shielding wall on a basis of the light-shielding and transmitting information generated by the light-shielding and transmitting information generation unit.

2. The light-shielding device according to claim 1,
wherein the light-shielding wall is a window that separates the first space and the second space,
the information indicating the state of the vicinity of the light-shielding wall is information indicating whether or not user's eyes are present in a vicinity of the window constituted by the light-shielding wall, and
the light-shielding and transmitting information generation unit generates light-shielding and transmitting information for controlling the transmitting state or the light-shielding state of the position of each of the plurality of regions on a basis of information that indicates the state of the vicinity of the light-shielding wall and indicates whether or not the user's eyes are present in the vicinity of the window constituted by the light-shielding wall.

3. The light-shielding device according to claim 2,
wherein on a basis of the information that indicates the state of the vicinity of the light-shielding wall and indicates whether or not the user's eyes are present in the vicinity of the window constituted by the light-shielding wall, the light-shielding and transmitting information generation unit generates light-shielding and transmitting information for controlling a region, which corresponds to a position of the user's eyes, in the light-shielding wall to the transmitting state, and controlling the other regions to the light-shielding state in a case where the position of the user's eyes is present in the vicinity of the window constituted by the light-shielding wall, and for controlling the entirety of the regions of the light-shielding wall to the light-shielding state in a case where the position of the user's eyes is not present in the vicinity of the window constituted by the light-shielding wall.

4. The light-shielding device according to claim 3,
wherein the first space is a space in which an observation target exists, and the second space is an observation space for observation of the observation target,
the information indicating the state of the vicinity of the light-shielding wall further includes information indicating whether or not the light-shielding wall exists in a visual field of the observation target, and
the light-shielding and transmitting information generation unit generates light-shielding and transmitting information for controlling the transmitting state or the light-shielding state of the position of each of the plurality of regions on a basis of the information indicating whether or not the light-shielding wall exists in the visual field of the observation target, and the information indicating whether or not the user's eyes are present in the vicinity of the window constituted by the light-shielding wall.

5. The light-shielding device according to claim 4,
wherein the light-shielding and transmitting information generation unit generates,
light-shielding and transmitting information for controlling the transmitting state or the light-shielding state of the position of each of the plurality of regions on a basis of the information indicating whether or not the user's eyes are present in the vicinity of the window constituted by the light-shielding wall in a case where the light-shielding wall exists in the visual field of the observation target, and
light-shielding and transmitting information for controlling the entirety of the plurality of regions to the transmitting state in a case where the light-shielding wall does not exist in the visual field of the observation target.

6. The light-shielding device according to claim 5,
wherein the case where the light-shielding wall does not exist in the visual field of the observation target includes a case where the observation target is sufficiently spaced away from the light-shielding wall.

7. The light-shielding device according to claim 1,
wherein the light-shielding wall is a floor that separates the first space and the second space,
the information indicating the state of the vicinity of the light-shielding wall is information indicating whether or not a user steps into a new position on the floor, and
the light-shielding and transmitting information generation unit generates light-shielding and transmitting information for controlling the transmitting state or the light-shielding state of the position of each of the plurality of regions on a basis of the information that indicates the state in the vicinity of the light-shielding wall and indicates whether or not the user steps into the new position on the floor.

8. The light-shielding device according to claim 7,
wherein the light-shielding and transmitting information generation unit generates light-shielding and transmitting information for controlling the region at a stepped position of a foot of the user to the transmitting state in a case where the user steps into a new position on the floor, and controlling the other regions to the light-shielding state.

9. The light-shielding device according to claim 7,
wherein the light-shielding and transmitting information generation unit generates light-shielding and transmitting information for controlling the region at a stepped position of a foot of the user to the light-shielding state in a case where the user steps into a new position on the floor, and controlling the other regions to the transmitting state.

10. The light-shielding device according to claim 1,
wherein the light-shielding wall is a window that separates the first space and the second space,
the light-shielding device further comprises a lock control unit that controls locking and unlocking of a lock of the window,
the information indicating the state in the vicinity of the light-shielding wall is information indicating whether or not a suspicious person is present,
the light-shielding and transmitting information generation unit generates light-shielding and transmitting information for controlling the transmitting state or the light-shielding state of the position of each of the plurality of regions on a basis of the information that indicates the state of the vicinity of the light-shielding wall and indicates whether or not the suspicious person is present, and
the lock control unit controls locking or unlocking of the lock of the window on a basis of the information indicating whether or not the suspicious person is present.

11. The light-shielding device according to claim 10,
wherein in a case where the suspicious person is present,
the light-shielding and transmitting information generation unit generates light-shielding and transmitting information for controlling the plurality of regions in a visual field of the suspicious person to the light-shielding state and controlling the other regions to the transmitting state, and
the lock control unit controls the lock of the window to be locked, and
in a case where the suspicious person is not present,
the light-shielding and transmitting information generation unit generates light-shielding and transmitting information for controlling the entirety of the regions to the transmitting state, and
the lock control unit controls the lock of the window to be unlocked.

12. The light-shielding device according to claim 1,
wherein the light-shielding wall is a road wall that separates a road and a resident area at a roadside,
the information indicating the state of the vicinity of the light-shielding wall is information indicating whether or not a vehicle, in which the resident area is visible to an occupant through the light-shielding wall in the transmitting state, travels on the road, and
the light-shielding and transmitting information generation unit generates the light-shielding and transmitting information for controlling the transmitting state or the light-shielding state of the position of each of the plurality of regions on a basis of the information that indicates the state in the vicinity of the light-shielding wall and indicates whether or not the vehicle, in which the resident area is visible to the occupant through the light-shielding wall in the transmitting state, travels on the road.

13. The light-shielding device according to claim 12,
wherein on a basis of the information that indicates the state of the vicinity of the light-shielding wall and indicates whether or not the vehicle, in which the resident area is visible to the occupant through the light-shielding wall in the transmitting state, travels on the road, the light-shielding and transmitting information generation unit generates light-shielding and transmitting information for controlling a region in the light-shielding wall in which the resident area is visible to the occupant to the light-shielding state and controlling the other regions to the transmitting state in a case where the vehicle, in which the resident area is visible to the occupant through the light-shielding wall in the transmitting state, travels on the road, and for controlling the entirety of the regions of the light-shielding wall to the transmitting state in a case where the vehicle, in which the resident area is visible to the occupant through the light-shielding wall in the transmitting state, does not travel on the road.

14. A light-shielding method of a light-shielding device including a light-shielding wall that partitions a first space and a second space and includes a plurality of regions capable of being controlled to a transmitting state in which light is transmitted or a light-shielding state in which light is shielded, the method comprising steps of:
generating light-shielding and transmitting information for controlling the transmitting state or the light-shielding state of a position of each of the plurality of regions on a basis of information indicating a state of a vicinity of the light-shielding wall; and
controlling the transmitting state or the light-shielding state of the plurality of regions of the light-shielding wall on a basis of the light-shielding and transmitting information that is generated.

15. A program that allows a computer to function as:
a light-shielding wall that partitions a first space and a second space and includes a plurality of regions capable of being controlled to a transmitting state in which light is transmitted or a light-shielding state in which light is shielded;
a light-shielding and transmitting information generation unit that generates light-shielding and transmitting information for controlling the transmitting state or the light-shielding state of a position of each of the plurality of regions on a basis of information indicating a state of a vicinity of the light-shielding wall; and
a control unit that controls the transmitting state or the light-shielding state of the plurality of regions of the light-shielding wall on a basis of the light-shielding and transmitting information generated by the light-shielding and transmitting information generation unit.
